(19) United States
(12) Patent Application Publication
(10) Pub. No.: US 2025/0249450 A1
(43) Pub. Date: Aug. 7, 2025

(54) DIAGNOSTIC CHIP CARRIER DEVICE WITH GASKET AND METHODS OF MANUFACTURE

(71) Applicant: Cepheid, Sunnyvale, CA (US)

(72) Inventors: Douglas B. Dority, Mill Valley, CA (US); Ryan Flowe, Sunnyvale, CA (US); Rohan Kurse, Sunnyvale, CA (US); Pradeep Magadum, Sunnyvale, CA (US); Mandeep Singh Sandhu, Sunnyvale, CA (US); Brian Eric Lee, Sunnyvale, CA (US); Daniel Sturman, Sunnyvale, CA (US); Baltej Pannu, Sunnyvale, CA (US); Dalton Scott, Sunnyvale, CA (US); Kavya Umachandran, Sunnyvale, CA (US)

(73) Assignee: Cepheid, Sunnyvale, CA (US)

(21) Appl. No.: 19/042,886

(22) Filed: Jan. 31, 2025

Related U.S. Application Data
(60) Provisional application No. 63/549,316, filed on Feb. 2, 2024.

(51) Int. Cl. B01L 3/00

(52) U.S. Cl. CPC B01L 3/502715; B01L 2200/027; B01L 2200/04; B01L 2200/0689; B01L 2300/168

(57) ABSTRACT

Diagnostic chip devices, and methods and devices for assembly and manufacture, are described. Such chip device includes a chip carrier device that includes a frame having a fluidic interface, one or more fluidic channels and a gasket that forms a flowcell sealed against an active surface of a diagnostic chip. The gasket can be overmolded into the frame, or can be separately applied and compressed by the chip, which can be secured to the frame by cold swaging, hot swaging or heat staking, adhesive or any suitable means. The chip carrier device can further include a window over the flowcell to allow for optical detection of the active face of the chip. The window can be formed by a transparent lid or glass insert attached to the frame by laser welding, overmolding, adhesive or any suitable means. The carrier and lid can also be formed as a single integral component.

### CROSS-REFERENCES TO RELATED APPLICATION

This application claims the benefit of and priority to U.S. Application No. 63/549,316, filed on Feb. 2, 2024, entitled DIAGNOSTIC CHIP CARRIER DEVICE WITH GASKET AND METHODS OF MANUFACTURE, the disclosure of which is hereby incorporated by reference in its entirety.

This application is generally related to U.S. application Ser. Nos. 16/713,455 entitled “Diagnostic Chip Devices and Methods of Manufacture and Assembly” filed Dec. 13, 2019; Ser. No. 16/577,650 entitled “System, Device and Methods of Sample Processing Using Semiconductor Diagnostic Chips” filed on Sep. 20, 2019; Ser. No. 15/718,840 entitled “Fluidic Bridge Device and Sample Processing Methods” filed Sep. 28, 2017; U.S. Pat. No. 6,374,684 entitled “Fluid Control and Processing System,” filed Aug. 25, 2000; and U.S. Pat. No. 8,048,386 entitled “Fluid Processing and Control,” filed Feb. 25, 2002; each of which is incorporated herein by reference in its entirety for all purposes.

### BACKGROUND

The present disclosure relates generally to a system, device and methods for fluid sample manipulation and analysis, in particular, for transport of a fluid sample from a sample processing device into a chip carrier device for analysis using a semiconductor chip.

In recent years, there has been considerable development in the use of semiconductor diagnostic chips in performing fluid sample analysis (e.g. testing of clinical, biological, or environmental samples). One continual challenge in conventional MEMs technologies in diagnostics has been the lack of flexible sample preparation front end to provide a fluid sample suitable for analysis with the semiconductor chips. Sample preparation of such fluid samples typically involves a series of processing steps, which can include chemical, optical, electrical, mechanical, thermal, or acoustical processing of the fluid samples. Whether incorporated into a bench-top instrument, a portable analyzer, a disposable cartridge, or a combination thereof, such processing typically involves complex fluidic assemblies and processing algorithms. Developing a robust fluid sample processing system can be extremely challenging and costly.

Conventional approaches for processing fluid samples typically involves substantial manual operation, while more recent approaches have sought to automate many of the processing steps and can include the use of sample cartridges that employ a series of regions or chambers each configured for subjecting the fluid sample to a specific processing step. As the fluid sample flows through the cartridge sequentially from region or chamber to a subsequent region or chamber of the cartridge, the fluid sample undergoes the processing steps according to a specific protocol. Such systems, however, generally include an integrated means of analysis, and are not typically amenable to use with a semiconductor chip. The standard approach of utilizing semiconductor diagnostic chips, such as “lab on a chip” devices, generally requires a considerably complex, time-consuming and costly endeavor, requiring the chip be incorporated into a conventional chip package and then incorporated into much larger systems utilizing conventional fluidic transport means to transport a fluid sample to the chip device. The fluid sample is typically prepared by one or more entirely separate systems (often including manual interaction) and then pipetted into the fluid transport system to be supplied to the chip package. These challenges associated with pre and post testing processes often minimize the advantages and benefits of such “lab on a chip” devices and present a practical barrier to their widespread use and acceptance in diagnostic testing. Another drawback or limitation associated conventional approaches of MEMS diagnostics technology is cost. In order to make high functionality MEMS/silicon chip technologies feasible in the context of high volume diagnostic testing, the costs of the device should be as low as possible.

Thus, there is need for approaches that lower the costs of diagnostic chips and improve integration with fluidics and optics to provide improved operation and detection. There is further need for developing a chip carrier device that is compatible with existing sample processing technologies and sample cartridges to allow for seamless integration with existing sample preparation technologies to overcome the challenges described above.

### SUMMARY

The present disclosure provides diagnostic chips and chip devices (also referred to as “chip,” “diagnostic chip,” or “semiconductor chip”) that facilitate use of the chip with sample processing devices and systems that transport processed fluid sample for analysis with the chip. The devices described herein are specifically configured for semiconductor diagnostic chips that utilize fluorescence detection, for example time-gated biochips (e.g., CRONUS). Various approaches are provided that further streamline the use of such chips by improving integration of various features of the semiconductor chip within a chip carrier device.

In one aspect, the chip carrier device includes a frame having a fluidic interface, one or more fluidic channels and an overmolded gasket that forms a flowcell that is sealed against an active surface of a diagnostic chip. The chip is held against the flowcell by a printed circuit board (PCB) or substrate that is attached to the frame. The chip carrier device further includes a window adjacent the flowcell to allow for optical detection of the active face of the chip. The window can be formed by a transparent lid (as a separate component or integrated feature of the frame) or a glass insert molded within the frame.

In another aspect, the device substantially reduces the size of a PCB on which the semiconductor chip is provided, for example utilizing contacts in an electrical interface that is co-adjacent or on a same side as the active surface of the diagnostic chip. The frame can include an access window to allow contact (e.g. probes) of an instrument interface to engage the contacts to allow operation of the chip by an instrument interface of a receiving module.

In yet another aspect, the disclosure pertains to chip devices compatible for use with chip carrier devices configured to utilize existing sample processing technologies to perform one or more processing steps, then transport the processed fluid sample to interface with the semiconductor chip and perform further processing with the chip. Such further processing typically includes analysis of a target analyte. In some embodiments, the disclosure further provides means for any of: powering a chip device, communicating, programming or signal processing when performing testing with a semiconductor diagnostic chip device. In one aspect, the chip carrier device is configured for use with any of differing types of chips and allows for a plug-n-play approach to utilizing semiconductor diagnostic chips. In some embodiments, the chip carrier device is configured to receive and securely engage with a diagnostic chip having an active area, the chip device having a flowcell chamber that sealingly engages with the active area when secured within the chip carrier device.

It is appreciated that the chip device can include any type of semiconductor diagnostic chip, but is particularly applicable to a diagnostic chip utilizing fluorescence detection, such as a CMOS luminescence chip or time-gated biochip (e.g., CRONUS). One or more of the concepts herein can also be applied to carrier devices for various other types of chips, including but not limited to ion-sensitive FET (ISFET), bulk acoustic, non-bulk acoustic, piezo-acoustic, and pore array sensor chips. In some embodiments, the semiconductor diagnostic chip serves as a biosensor that combines a biologically sensitive element with a physical or chemical transducer to selectively (and in some embodiments, quantitatively) detect the presence of specific analytes in a fluid sample. In some embodiments, the chip provides an electrical or optical output signal in response to a physical, chemical, or optical input signal. The system or module used with the chip carrier device can include features for powering, communication, signal integration, and data flow when performing testing with the diagnostic chip and can include software to facilitate use of the chip within the system. In some embodiments, to enable additional new or enhanced functionality, one or more features that provide sample processing and/or sample preparation capabilities amenable to silicon-based technologies can be included on the silicon chip. For example, the chip could include one or more features for more refined fluidic manipulation, further refined sample processing, or any compatible sample processing and/or preparation steps. Such technologies and functionalities could include but are not limited to: electrophoretic-based separation; fluidic pumping; and electrowetting-based fluidic manipulation, including droplet generation or pumping, flow sensors, and the like. In some embodiments, the chip can be bio-functionalized. The chip can utilize bio-functionalized materials (e.g., nanosheets, nanotubes, nanoparticles), for example, as surfaces or coatings. In some embodiments, a surface is bio-functionalized to facilitate controlled movement or immobilization of a probe or target. It is appreciated that any of these chip features described above could be included in any of the embodiments described herein, and further that the chip carrier can be adapted for use with such chip features.

In some embodiments, the chip device is electricially coupled to multiple probe contact pads without any backside contacts by PCB via connections. This allows for a streamlined chip design in which the probe contacts are accessible from a same side of the chip as the active area. In some embodiments, the chip device includes a separate electrical interface having multiple probe contact pads, the separate electrical interface disposed adjacent the chip when carried within the chip carrier portion. In some embodiments, the electrical interface can be a PCB having an area less than the diagnostic chip. Advantageously, the electrical interface can be defined as flex PCB and the probe contacts of the electrical interface are electrically connected to corresponding contacts of the chip by TAB bonds. In some embodiments, the chip is provided on a support substrate comprising a flex PCB, polymer film or self-adhesive flex laminate. In other embodiments, the chip is defined without any support substrate separate (e.g. rigid PCB underlying the chip) from a semiconductor wafer in which the chip is defined. In such embodiments, the chip can include a plurality of probe contacts defined within the chip itself and the chip carrier portion can include a window through which the plurality of probe contacts are accessible when the chip is secured within the chip carrier portion and scalingly engaged with the flowcell chamber. In some embodiments, the chip includes a support subtrate of a thermally conductive metal (e.g. copper).

In another aspect, the disclosure pertains to more cost-effective, streamlined diagnostic chip designs and methods of manufacture and assembly within the chip carrier device with an integrated flowcell chamber. Such diagnostic chips can be a silicon device comprising an active area configured for diagnostic detection of fluid sample in contact during operation and a plurality of contacts that are electrically connected to the active area for powering and communication with the active area. Advantageously, the plurality of contacts can be provided on a same side of the chip as the active area. This allows for a chip that is electrically connected without any backside via connections, thereby simplifying the chip design and process workflow. In some embodiments, the chip comprises a support structure of a self-adhesive flex laminate. The contacts can be electrically connected to a separate PCB having a plurality of probe contact pads on the same side as the active area. In some embodiments, the chip includes a support structure of a thermally conductive metal, such as copper, to facilitate thermal cycling. In other embodiments, the chip is without any support substrate separate from the silicon wafer in which the chip is defined. In such embodiments, the contacts can be defined as probe contact pads within the chip itself and disposed on the same side of the chip as the active area.

In yet another aspect, the disclosure pertains to a system that includes a sample cartridge configured to hold an unprepared sample, the sample cartridge having multiple processing chambers fluidically interconnected by a moveable valve body; a module (also referred to as a “cartridge processing module” or “module”) for performing sample preparation, the module having a cartridge receiver adapted to receive and removably couple with the sample cartridge and configured to perform sample preparation; and a diagnostic chip device secured within a chip carrier device. The chip carrier device is fluidically coupleable to the sample cartridge via the fluidic interface and electrically coupleable with the module for powering and communication with a diagnostic chip secured within the chip device. The diagnostic chip device can be in accordance with any of those described herein.

In still another aspect, the disclosure pertains to methods of fabricating a diagnostic chip for use. Such methods can include defining a diagnostic chip having an active surface that is electrically connected to a plurality of electrical contacts accessible from a same side as the active surface. In some embodiments, the diagnostic chip is defined to electrically connect without backside contacts having vias through any underlying rigid support substrate (e.g. PCB). This allows for alternative support structures (e.g. flex PCB, laminates, metal or substrates of reduced size and thickness). In some embodiments, the chip device is configured to electrically connect the active surface to a plurality of probe contact pads without any wire bonds. In some embodiments, the chip device is designed entirely without any separate underlying support substrate (e.g. rigid PCB). In some embodiments, the probe contacts can be formed in the chip itself, either along the same side as the active surface or along the opposite side. While the chip carrier device is designed for diagnostic chips that utilized fluorescence detection, it is appreciated that these features and methods can also be used in chip carrier device for various other types of diagnostic chips, including any of CMOS, ISFET, bulk acoustic, non-bulk acoustic, piezo-acoustic and pore array sensor chips. It is appreciated that such chip carrier devices could be formed of separate components or a unitary integral component.

In one aspect, the disclosure pertains to a diagnostic chip carrier device that includes: a planar frame having a fluidic interface at one end that is fluidically coupled to one or more fluidic passages extending to a chip receiving region (e.g. contoured or recessed region shaped to receive the chip) near the opposite end, the recessed region being disposed on a major planar face and shaped to receive a diagnostic chip; a flowcell chamber adjacent to the recessed region such that an active surface of the chip is exposed to the flowcell chamber when disposed within the recessed region; and an opening adjacent the flowcell chamber on an opposite major face of the planar frame to allow optical detection through the opening of the active surface of the diagnostic chip when disposed within the contoured region. It is appreciated that the recessed region or contoured region described in any of the embodiments herein could instead be any chip receiving region shaped and dimensioned to receive a chip secured to the frame.

In another aspect, the chip carrier device can include a gasket that is overmolded within the carrier or separately formed and placed within the recessed region that receives the chip around the flowcell chamber. The gasket formed of a compressible material such that when compressed by the chip secured in the frame, the gasket compresses to form a fluid-tight seal. In some embodiments, the gasket is formed of silicone. In some embodiments, the gasket is formed of silicone having a shore hardness of 50 A-60 A. In some embodiments, the gasket has a thickness of 0.40-0.7 mm. In some embodiments, the gasket has a substantially circular cross-section. In some embodiments, the gasket has a substantially square in shape that corresponds in size and shape to the recessed region. It is appreciated that the gasket could be formed in various shaped, for example any shape designed to suitably conform to the frame when compressed to form a fluid-tight seal between the flowcell chamber and the active material of the chip.

In yet another aspect, the chip carrier device can include one or more ridges circumscribing the flowcell chamber that increase the compressive energy applied by the chip when secured to the frame so as to increase compression of the gasket to facilitate sealing around the flowcell chamber. In some embodiments, the carrier frame includes a single energy directing ridge, in other embodiments, the carrier frame includes two or more energy directing ridges. It is appreciated that, as used herein, an “energy director” or “energy directing” ridge or feature can refer to any feature designed to provide sealing (e.g. sealing ridge, scaling ring) and can be any suitable shape for a given frame design. Therefore, the term “energy director” or “energy directing” ridge is not limited to ultrasonic welding features and can encompass any shape or feature that can be molded into a gasket or molded into a substrate part that engages with a flat gasket.

In still another aspect, the diagnostic chip carrier device can include a pair of swage beams on opposite sides of the recessed region to facilitate swaging of the diagnostic chip within the recessed region with the gasket disposed between the chip and the frame. In some embodiments, the pair of swage beams each includes a ridge or lip of material disposed above and below the recessed region so as to flow over the edge of the chip by cold swaging or hot swaging.

In another aspect, the diagnostic chip carrier device can include a plurality of posts on the frame arranged about the recessed region to facilitate heat staking of the chip within the recessed region. The device can further include a retainer bracket having a plurality of holes for receiving the posts, the bracket being shaped to engage the chip for securing to the frame. In some embodiments, the retainer bracket is U-shaped and dimensioned to extend along at least three edges of the frame to retain the chip within the recessed region. In some embodiments, the retainer bracket is metal and the posts are flowable polymer materials, typically integrally formed with the frame.

In yet another aspect, the chip carrier device can include a planar frame that further includes an access opening positioned to allow access to a plurality of contacts disposed on the diagnostic chip when disposed within the contoured region. In some embodiments, the planar frame further includes a ridge within the recessed region between the gasket and the access opening to prevent excess gasket from extending within the access opening when compressed during securing of the chip to the frame.

In still another aspect, the chip carrier device can further include an optical lid secured to the opposite major face of the planar frame and enclosing one side of the flowcell chamber to allow optical detection of the active face of the chip when secured within the recessed portion. In some embodiments, the optical lid is a molded component and includes an access opening that overlays the access opening in the frame. In some embodiments, the optical lid is secured to the planar frame by laser welding. In some embodiments, the frame includes a flattened ridge around the flowcell chamber and the one or more fluidic passages to facilitate laser welding of the optical lid and fluidic sealing of the flowcell chamber and the one or more fluidic passages. In some embodiments, the frame includes a flattened raised plateau region extending around the flowcell chamber and the one or more fluidic passages to facilitate laser welding of the optical lid and fluidic sealing of the flowcell chamber and the one or more fluidic passages. In some embodiments, the optical lid is glass. In some such embodiments, the optical lid is secured to the planar frame by adhesive or by overmolding. In some embodiments the frame and optical lid are molded as a single piece.

In another aspect, the disclosure pertains to a heat staking fixture for securing the diagnostic chip to the chip carrier frame by heat staking. In some embodiments, the fixture includes a base, a clamp, a latch to apply pressure and a thermal probe to apply heat. In some embodiments, the base includes a nesting region to hold a planar frame having a fluidic interface at one end that is fluidically coupled to one or more fluidic passages extending to a recessed region shaped near the opposite end, the recessed region being disposed on a major planar face and shaped to receive a diagnostic chip, the frame having a plurality of posts. In some embodiments, the clamp that is pivotally coupled with the base to overlay the planer frame held within the nesting region, the clamp having an open region for holding a retaining bracket in position to be received over the posts of the frame. In some embodiments, the latch for applying pressure on the clamp, in turn, applying pressure on the retaining bracket to secure the chip within the recessed portion and apply pressure to the distal end of the plurality of posts. In some embodiments, the thermal probe applied on the clamp to facilitate heat staking of the plurality of posts atop the retainer bracket.

In still another aspect, the disclosure pertains to a gasket positioning device that includes an elongate tool that picks up and places a gasket within the chip recess of the carrier frame. The elongate tool can be manually positions and actuated and/or robotically positioned and actuated. In some embodiments, the device includes an elongate tool extending to a distal grasper configured to pick up and release a gasket at a pre-determined position within the grasper and having one or more alignment features; and a fixture base configured with a nesting region to support a chip carrier frame, wherein the fixture base includes one or more corresponding alignment features configured to engage with the alignment features of the grasper to ensure positioning of the gasket within a recessed portion of the chip carrier frame. In some embodiments, the one or more alignment features includes a non-symmetrical feature or protrusion(s), for example, three or more protruding arms that engage at least three edges of the frame and/or fixture base. In some embodiments, the grasper includes one or more ports coupled to a suction and pressurization means, to facilitate picking up the gasket by suction and release of the gasket by compressed air. In some embodiments, the tool is manually held and positioned and the grasper is actuated by a manual control.

In yet another aspect, the disclosure pertains to a method of assembling a diagnostic chip carrier device. Such methods can include: placing a gasket within a recessed region of a planar frame having a fluidic interface at one end that is fluidically coupled to one or more fluidic passages extending to the recessed region shaped near the opposite end, the recessed region being disposed on a major planar face and shaped to receive a diagnostic chip, the planar frame further including a flowcell chamber within the recessed region; placing the diagnostic chip over the gasket within the recessed region of the planar frame; securing the chip to the frame, thereby compressing the gasket between the chip and the frame to form a fluid-tight seal; and securing an optical lid to the opposite major face of the planar frame, thereby enclosing the flowcell chamber. In some embodiments, securing the chip to the frame includes swaging a pair of swage bars of the frame along opposite sides of the chip. Swaging can be cold swaging or hot swaging. In some embodiments, securing the optical lid includes laser welding the optical lid to the frame. In some embodiments, the optical lid and frame can be integrally formed as a single piece.

It is appreciated that variations of the above embodiment can be realized. It is further appreciated that a particular chip carrier device could include one or more of the aspects or features described above in any feasible combination. The above noted aspects and features can be further understood by referring to the figures described below.

### BRIEF DESCRIPTION OF THE DRAWINGS

FIG. 1 illustrates a sample cartridge fluidically coupled with a chip carrier device in accordance with some embodiments of the disclosure.

FIG. 2 illustrates a diagnostic processing system with modules that receive and process the sample cartridge in FIG. 1 in accordance with some embodiments.

FIG. 3 illustrates a chip carrier device, in accordance with some embodiments.

FIG. 4 illustrates an exploded view of a chip carrier device with transparent lid, in accordance with some embodiments.

FIG. 5A illustrates a side view of the chip carrier device in FIG. 4, in accordance with some embodiments.

FIG. 5B illustrates a side view of the chip carrier device in FIG. 4, in accordance with some embodiments.

FIG. 6 illustrates an alternative embodiment of a chip carrier device with a glass window, in accordance with some embodiments.

FIG. 7A illustrates a side view of the chip carrier device in FIG. 6, in accordance with some embodiments.

FIG. 7B illustrates a side view of the chip carrier device in FIG. 6, in accordance with some embodiments.

FIG. 8A illustrates methods of assembling a diagnostic chip within the chip carrier device, in accordance with some embodiments.

FIG. 8B illustrates a detail view of an assembled diagnostic chip within a chip carrier device, in accordance with some embodiments.

FIG. 9 illustrates an injection molding tool for fabricating the frame and overmolded gasket of the chip carrier device, in accordance with some embodiments.

FIG. 10A illustrates a detail view of molding tools for fabricating the frame and gasket and lid of the chip carrier device, in accordance with some embodiments.

FIG. 10B illustrates a detail view of molding tools for fabricating the frame and gasket and lid of the chip carrier device, in accordance with some embodiments.

FIG. 11A illustrates a detail view of molding tools for fabricating the frame and gasket and lid of the chip carrier device, in accordance with some embodiments.

FIG. 11B illustrates a detail view of molding tools for fabricating the frame and gasket and lid of the chip carrier device, in accordance with some embodiments.

FIG. 11C illustrates a detail view of molding tools for fabricating the frame and gasket and lid of the chip carrier device, in accordance with some embodiments.

FIG. 12A illustrates fixtures for scalingly attaching the optical lid and frame of the chip carrier device, in accordance with some embodiments.

FIG. 12B illustrates fixtures for scalingly attaching the optical lid and frame of the chip carrier device, in accordance with some embodiments.

FIG. 13A illustrates volumetric capacities of the cartridge and fluidic channels and flowcell of the chip carrier device, in accordance with some embodiments.

FIG. 13B illustrates volumetric capacities of the cartridge and fluidic channels and flowcell of the chip carrier device, in accordance with some embodiments.

FIG. 14 demonstrates differing optical properties of differing optical lid materials, in accordance with some embodiments.

FIG. 15A demonstrates a fabrication method for producing a chip carrier device with a glass window, in accordance with some embodiments.

FIG. 15B demonstrates a fabrication method for producing a chip carrier device with a glass window, in accordance with some embodiments.

FIG. 15C demonstrates a fabrication method for producing a chip carrier device with a glass window, in accordance with some embodiments.

FIG. 15D demonstrates a fabrication method for producing a chip carrier device with a glass window, in accordance with some embodiments.

FIG. 15E demonstrates a fabrication method for producing a chip carrier device with a glass window, in accordance with some embodiments.

FIG. 15F demonstrates a fabrication method for producing a chip carrier device with a glass window, in accordance with some embodiments.

FIG. 15G demonstrates a fabrication method for producing a chip carrier device with a glass window, in accordance with some embodiments.

FIG. 15H demonstrates a fabrication method for producing a chip carrier device with a glass window, in accordance with some embodiments.

FIG. 15I demonstrates a fabrication method for producing a chip carrier device with a glass window, in accordance with some embodiments.

FIG. 15J demonstrates a fabrication method for producing a chip carrier device with a glass window, in accordance with some embodiments.

FIG. 16A demonstrates another fabrication method for producing a chip carrier device with a glass window, in accordance with some embodiments.

FIG. 16B demonstrates another fabrication method for producing a chip carrier device with a glass window, in accordance with some embodiments.

FIG. 16C demonstrates another fabrication method for producing a chip carrier device with a glass window, in accordance with some embodiments.

FIG. 16D demonstrates another fabrication method for producing a chip carrier device with a glass window, in accordance with some embodiments.

FIG. 16E demonstrates another fabrication method for producing a chip carrier device with a glass window, in accordance with some embodiments.

FIG. 16F demonstrates another fabrication method for producing a chip carrier device with a glass window, in accordance with some embodiments.

FIG. 16G demonstrates another fabrication method for producing a chip carrier device with a glass window, in accordance with some embodiments.

FIG. 16H demonstrates another fabrication method for producing a chip carrier device with a glass window, in accordance with some embodiments.

FIG. 16I demonstrates another fabrication method for producing a chip carrier device with a glass window, in accordance with some embodiments.

FIG. 17 illustrates a view of another exemplary chip carrier device with a glass window, in accordance with some embodiments.

FIG. 18 illustrates a view of another exemplary chip carrier device with a glass window, in accordance with some embodiments.

FIG. 19 illustrates a view of another exemplary chip carrier device with a glass window, in accordance with some embodiments.

FIG. 20 illustrates a view of another exemplary chip carrier device with a glass window, in accordance with some embodiments.

FIG. 21A illustrates alternative concepts for chip carrier devices, in accordance with some embodiments.

FIG. 21B illustrates alternative concepts for chip carrier devices, in accordance with some embodiments.

FIG. 21C illustrates alternative concepts for chip carrier devices, in accordance with some embodiments.

FIG. 21D illustrates alternative concepts for chip carrier devices, in accordance with some embodiments.

FIG. 22A illustrates alternative concepts for chip carrier devices, in accordance with some embodiments.

FIG. 22B illustrates alternative concepts for chip carrier devices, in accordance with some embodiments.

FIG. 22C illustrates alternative concepts for chip carrier devices, in accordance with some embodiments.

FIG. 22D illustrates alternative concepts for chip carrier devices, in accordance with some embodiments.

FIG. 23A illustrates differing types of gaskets in accordance with some embodiments.

FIG. 23B illustrates differing types of gaskets in accordance with some embodiments.

FIG. 23C illustrates differing types of gaskets in accordance with some embodiments.

FIG. 24 illustrates a chip carrier device design utilizing swaging of the chip to the frame over an overmolded gasket, in accordance with some embodiments.

FIG. 25A illustrates chip carrier device design utilizing a drop-in gasket and swaging of the chip to the frame, in accordance with some embodiments.

FIG. 25B illustrates chip carrier device design utilizing a drop-in gasket and swaging of the chip to the frame, in accordance with some embodiments.

FIG. 26 illustrates a flowchart for manufacturing a chip carrier device utilizing a drop-in gasket and swaging, in accordance with some embodiments.

FIG. 27 illustrates study results demonstrating the integrity of the gasket in response to swaging, in accordance with some embodiments.

FIG. 28 illustrates study results demonstrating the integrity of the gasket in response to swaging, in accordance with some embodiments.

FIG. 29 illustrates another chip carrier device having a welding surface for attaching the optical lid, in accordance with some embodiments.

FIG. 30 illustrates another chip carrier device having a welding plateau for attaching the optical lid and additional rib, in accordance with some embodiments.

FIG. 31A illustrates another chip carrier device utilizing a heat staking design and improved rib geometry, in accordance with some embodiments.

FIG. 31B illustrates another chip carrier device utilizing a heat staking design and improved rib geometry, in accordance with some embodiments.

FIG. 31C illustrates another chip carrier device utilizing a heat staking design and improved rib geometry, in accordance with some embodiments.

FIG. 32A illustrates a fixture for heat staking a chip to the frame of the device, in accordance with some embodiments.

FIG. 32B illustrates a fixture for heat staking a chip to the frame of the device, in accordance with some embodiments.

FIG. 32C illustrates a fixture for heat staking a chip to the frame of the device, in accordance with some embodiments.

FIG. 33A illustrates chip carrier devices utilizing single and double energy director features for the gasket, in accordance with some embodiments.

FIG. 33A-1 shows differing energy director ridge features for the gasket, in accordance with some embodiments.

FIG. 33A-2 shows differing energy director ridge features for the gasket, in accordance with some embodiments.

FIG. 33B illustrates chip carrier devices utilizing single and double energy director features for the gasket, in accordance with some embodiments.

FIG. 33B-1 shows differing energy director ridge features for the gasket, in accordance with some embodiments.

FIG. 34A illustrates a chip carrier device having added rib geometry along the access window for the electrical interface connector, in accordance with some embodiments.

FIG. 34B illustrates a chip carrier device having added rib geometry along the access window for the electrical interface connector, in accordance with some embodiments.

FIG. 35A illustrates a chip carrier device utilizing heat staking and additional rib geometry along the access window for the electrical interface connector, in accordance with some embodiments.

FIG. 35B illustrates a chip carrier device utilizing heat staking and additional rib geometry along the access window for the electrical interface connector, in accordance with some embodiments.

FIG. 36 illustrates a precision positioning fixture for assembling the drop-in gasket in a frame of a chip carrier device, in accordance with some embodiments.

FIG. 37A illustrates study results demonstrating improvement of the chip carrier design by hot swaging, in accordance with some embodiments.

FIG. 37B illustrates study results demonstrating improvement of the chip carrier design by hot swaging, in accordance with some embodiments.

FIG. 37C shows study results demonstrating changes in chip height between an overmolded gasket and a drop-in gasket, in accordance with some embodiments.

FIG. 37D shows study results demonstrating changes in chip height between an overmolded gasket and a drop-in gasket, in accordance with some embodiments.

FIG. 37E shows pressure loss associated with differing types of gaskets, in accordance with some embodiments.

FIG. 38A illustrates added edge feature on the optical lid to improve consistency in stacking of components in the chip carrier device during assembly to maintain integrity of the seal, in accordance with some embodiments.

FIG. 38B illustrates added edge feature on the optical lid to improve consistency in stacking of components in the chip carrier device during assembly to maintain integrity of the seal, in accordance with some embodiments.

FIG. 39A illustrates a chip carrier device having added rib geometry along the access window for the electrical interface connector, in accordance with some embodiments.

FIG. 39B illustrates a chip carrier device having added rib geometry along the access window for the electrical interface connector, in accordance with some embodiments.

FIG. 40A illustrates another chip carrier device having an improved welding path for the optical lid, in accordance with some embodiments.

FIG. 40B illustrates another chip carrier device having an improved welding path for the optical lid, in accordance with some embodiments.

FIG. 41A illustrates alternative chip carrier device and additional improvements pertaining to energy director ridges for the gasket, in accordance with some embodiments.

FIG. 41B illustrates alternative chip carrier device and additional improvements pertaining to energy director ridges for the gasket, in accordance with some embodiments.

FIG. 41C illustrates alternative chip carrier device and additional improvements pertaining to energy director ridges for the gasket, in accordance with some embodiments.

FIG. 42A illustrates alternative chip carrier device and additional improvements pertaining to the heat staking and frame rigidity, in accordance with some embodiments.

FIG. 42B illustrates alternative chip carrier device and additional improvements pertaining to the heat staking and frame rigidity, in accordance with some embodiments.

FIG. 43A illustrates alternative chip carrier device and additional improvements pertaining to the heat staking and frame rigidity, in accordance with some embodiments.

FIG. 43B illustrates alternative chip carrier device and additional improvements pertaining to the heat staking and frame rigidity, in accordance with some embodiments.

FIG. 44A shows study results demonstrating deformation of the chip carrier device of FIGS. 42A-42B, in accordance with some embodiments.

FIG. 44B shows study results demonstrating deformation of the chip carrier device of FIGS. 42A-42B, in accordance with some embodiments.

FIG. 44C shows study results demonstrating deformation of the chip carrier device of FIGS. 42A-42B, in accordance with some embodiments.

FIG. 45A shows study results demonstrating deformation of the chip carrier device of FIGS. 43A-43B, in accordance with some embodiments.

FIG. 45B shows study results demonstrating deformation of the chip carrier device of FIGS. 43A-43B, in accordance with some embodiments.

FIG. 45C shows study results demonstrating deformation of the chip carrier device of FIGS. 43A-43B, in accordance with some embodiments.

FIG. 46 shows study results showing a plot of pressure decay in a chip carrier device when utilizing an overmolded lip seal gasket, in accordance with some embodiments.

FIG. 47 illustrates a chip carrier and frame and optical lid injection molded as a single component, in accordance with some embodiments.

FIG. 48 shows a chip carrier device design utilizing liquid adhesive bonding, in accordance with some embodiments.

FIG. 49 shows a chip carrier device design utilizing liquid adhesive bonding, in accordance with some embodiments.

FIG. 50 show a chip carrier device design utilizing ultrasonic welding, in accordance with some embodiments.

FIG. 51 shows a chip carrier device design utilizing ultrasonic welding, in accordance with some embodiments.

FIG. 52A shows a biochip cartridge design using a fork for mounting the biochip carrier device to the cartridge body post-production, according to some embodiments.

FIG. 52B shows a biochip cartridge design using a fork for mounting the biochip carrier device to the cartridge body post-production, according to some embodiments.

### DETAILED DESCRIPTION

The present disclosure relates generally to devices configured for use with diagnostic detection chips and methods of manufacture and assembly. In particular, the disclosure pertains to a chip carrier device that carries a diagnostic detection chip and couples with a sample preparation cartridge to perform analytical testing by a receiving module, associated components, methods as well as devices and methods for manufacture and assembly.

### I. Overview

In one aspect, the disclosure pertains to an improved or streamlined chip carrier that improves functionality and reduces fabrication costs. In another aspect, the chip design improves integration with existing sample processing technologies by having features compatible with existing sample cartridges and sample preparation technologies. Such a chip carrier device includes fluid control features, such as one or more fluid conduits that are fluidly coupleable with one or more ports of a sample cartridge to facilitate transport of a processed fluid sample from the cartridge into the chip carrier device through the one or more fluid conduits to facilitate transport of the fluid sample to the semiconductor diagnostic chip in the chip carrier device. The sample cartridge is received by a module which facilitates operation of the sample cartridge to perform processing and transport of the processed fluid sample into the chip carrier device and includes an instrument interface that electrically connects to the chip carrier device to facilitate operation of the semiconductor chip carried within. In another aspect, the disclosure pertains to various improvements in chip carrier design for improving sealing, attachment between components and case of manufacture and assembly.

### A. Chip

As described herein, the term “chip” can refer to the chip itself or a chip device that includes the chip and an underlying support substrate and adjacent electrical interface that is electrically connected to the chip. Typically, the chip includes a silicon sensor element having an active face that is sealingly engaged with a flowcell filled with a prepared fluid sample (see U.S. Pat. No. 8,637,436). In some embodiments, the chip has an active surface that is substantially flat. In some embodiments, the active surface of the chip contains a pluralist of individual wells. In some embodiments, the chip device is designed and configured to be carried within a chip carrier device having an integrated flowcell and fluid control features so as to be compatible for use with a sample processing module as described above. The chip device can be placed within a contoured region or recess of a frame of the chip carrier device and secured by a substrate or PCB attached to the frame. The chip can be provided to the user already secured within a chip carrier device, or in some embodiments, an end user can assemble the chip within the chip carrier device.

In some embodiments, the semiconductor diagnostic chip is configured to perform sequencing of a nucleic acid target molecule by utilizing fluorescence detection of an active surface of the chip. For example, such chips can include CMOS fluorescence detection chips, such as a time-gated biochip (e.g., CRONUS). These chips can support time-gated fluorescence, in which, instead of using an optical filter to shield the sensor from the excitation wavelength, the fluorescence is designed using a chemistry that produces a long emission decay; the excitation source is rapidly turned off and the detector looks at the ‘afterglow’ as the signal. Thus, instead of wavelength exclusion, these chips utilize a time gate to ‘not look’ until the excitation source is turned off. The underlying technologies of such chips can be further understood by referring to U.S. Pat. No. 2020/0292457, entitled “Methods and systems for time-gated fluorescent-based detection,” which is incorporated herein in its entirety for all purposes. In other embodiments, the device can support diagnostic chips utilizing normal continuous wave fluorescence.

In other embodiments, the semiconductor diagnostic chip is configured to perform sequencing by other means, such as nanopore sequencing that detects changes in electrical conductivity that does not require optical excitation and/or detection. The underlying technologies of these chips can be further understood by referring to U.S. Pat. No. 8,986,928. In such embodiments, the chip carrier device need not include any optically transparent lid or window. In some embodiments, the semiconductor diagnostic chip analyzes other attributes of a target molecule in the sample, such as molecular weight and similar characteristics. Such technologies can be further understood by referring to: Xiaoyun Ding, et al. Surface acoustic wave microfluidics. Lab Chip. 2013 Sep. 21; 13 (18): 3626-3649. In some embodiments, the semiconductor diagnostic chip uses surface plasmon resonance to provide analysis of a target molecule, for example as used in the Biocore™ systems provided by GE Healthcare UK Limited and as described in their Biocore Sensor System Handbook (see gelifesciences.com/biacore). Each of the above references are incorporated herein by reference in their entirety.

### B. Chip Carrier Device

The chip carrier device is adapted to fluidically couple a semiconductor diagnostic chip to a sample cartridge as described herein. In some embodiments, the chip carrier device includes an electrical interface adapted to interface with an instrument interface board of a sample processing module which operates the sample processing cartridge. It is appreciated that the chip carrier device can be configured for use with any type of diagnostic chip. In some embodiments, the chip carrier device is designed to allow analysis of the biological fluid sample with the chip by electrical operation of the chip by the instrument interface of the module and optical detection of fluorescence of an active surface of the chip. Electrical operation can be accomplished through electrical probe contact pads of the chip that are accessed through an access opening in the chip carrier device and electrically connected to the instrument interface of the module. Optical detection can be accomplished through a portion of a transparent lid or by a glass window molded or in-laid within the chip carrier device. The chip carrier device can also be elongated so that the module can accommodate optical sensing instruments that are larger than those associated with conventional reaction vessels for PCR detection.

A configuration as described above allows for a more seamless transition between processing of the fluid sample with the sample cartridge and subsequent processing or analysis of the fluid sample with the chip in the chip carrier device. This configuration facilitates industry development of semiconductor chip devices by standardizing processing or preparation of the sample and delivery of the processed sample to the chip device. Preparation of the sample can be a time consuming and laborious process to perform by hand and can be challenging to develop within a next generation chip device. By utilizing a chip carrier device instead of the reaction tube, the user can utilize the sample cartridge to prepare the sample in a sample cartridge and subsequently transport the prepared sample into the attached chip carrier device for analysis with the semiconductor chip device carried therein. Such a configuration expedites development of semiconductor chips by utilizing existing sample preparation processes, originally configured for PCR detection, and allowing use of such processes with a chip device.

Typically, the chip carrier device is configured so that the processed fluid sample to be analyzed remains entirely contained within the chip carrier device having been introduced through the fluidic interface at one end of the device that is sealingly coupled to a sample cartridge. In other embodiments, the chip carrier device can include one or more processing features in fluid communication with one or more of the fluid flow channels, such as one or more chambers, filters, traps, membranes, ports and windows, to allow additional processing steps during transport of the fluid sample to the second sample processing device. Such chambers can be configured for use with an amplification chamber to perform nucleic acid amplification, filtration, chromatography, hybridization, incubation, chemical treatment. In some embodiments, the processing chamber allows for accumulation of a substantial portion of the fluid sample, if not the entire fluid sample, for further processing as needed for a particular protocol.

### C. Sample Cartridge

The sample cartridge can be any device configured to perform one or more process steps relating to preparation and/or analysis of a biological fluid sample according to any of the methods described herein. In some embodiments, the sample cartridge is configured to perform at least sample preparation. The sample cartridge can further be configured to perform additional processes, such as detection of a target nucleic acid in a nucleic acid amplification test (NAAT), e.g., Polymerase Chain Reaction (PCR) assay, by use of a reaction tube attached to the sample cartridge. Preparation of a fluid sample generally involves a series of processing steps, which can include chemical, electrical, mechanical, thermal, optical or acoustical processing steps according to a specific protocol. Such steps can be used to perform various sample preparation functions, such as cell capture, cell lysis, binding of analyte, and binding of unwanted material.

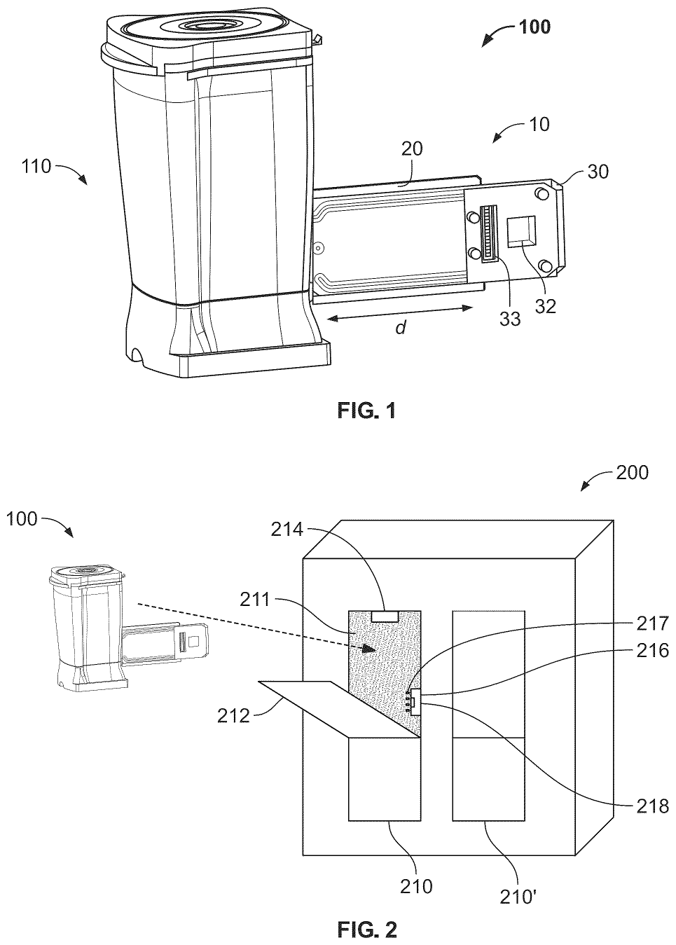

A sample cartridge suitable for use with the disclosure, includes one or more transfer ports through which the prepared fluid sample can be transported into a reaction tube for analysis. FIG. 1 illustrates cartridge assembly 100 that includes a sample cartridge 110 fluidically coupled to a diagnostic chip carrier device 10 (the cartridge assembly may also be referred to as “biochip cartridge”) in accordance with some embodiments. Conventionally, such a sample cartridge is associated with a planar reaction tube adapted for analysis of a fluid sample processed within the sample cartridge 110. Such a sample cartridge includes various components including a main housing having one or more chambers for processing of the fluid sample, which typically include sample preparation before analysis. In accordance with its conventional use, after the sample cartridge and reaction tube are assembled and a biological fluid sample is deposited within a chamber of the sample cartridge, the cartridge is inserted into a system module 210′ configured for sample preparation and analysis (as shown in FIG. 2). The cartridge processing module then facilitates the processing steps needed to perform sample preparation and the prepared sample is transported through one of a pair of transfer ports into the fluid conduit of the reaction tube attached to the housing of the sample cartridge. The prepared biological fluid sample is then transported into a chamber of the reaction tube through a fluidic interface of the reaction tube where the biological fluid sample undergoes nucleic acid amplification and testing to indicate the presence or absence of a target nucleic acid analyte of interest, e.g., a bacteria, a virus, a pathogen, a toxin, or other target analyte, for example by use of an excitation and optical detection means. Such a sample cartridge can also be utilized to perform analysis with the semiconductor chips described herein by use of a chip carrier device, which is fluidically coupleable to the sample cartridge in the same or similar manner as a conventional reaction tube.

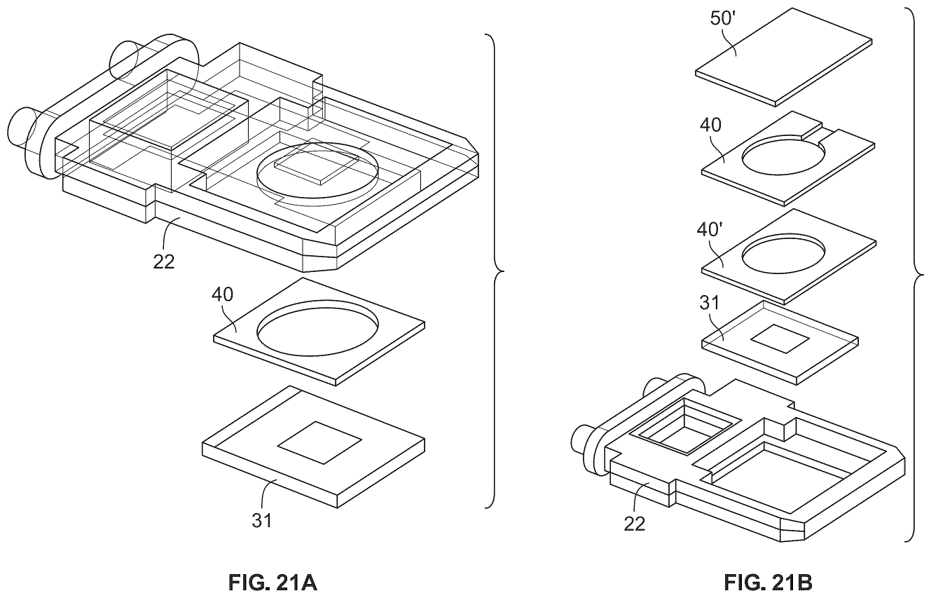

In this embodiment, the chip carrier device includes an elongated portion 20 with one or more fluidic channels that extends distally to chip carrying portion 30, which includes the diagnostic chip within. The contacts 33 of the chip remain accessible through the device and the active surface 32 of the chip remains visible through a window or lid for optical detection by an instrument interface of the system module. In this embodiment, the elongated portion 20 extends a distance d so as to accommodate the instrument interface, which may be larger than conventional optical detection units for conventional reaction vessels. It is appreciated, however, that in other embodiments, the chip carrier device can be shorter or substantially square, such as the embodiment show in FIG. 20, for use with other module configurations or optical units.

An exemplary use of a sample cartridge with a planar reaction tube configured for controlled fluid control of a prepared fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of the sample cartridge and associated module are also shown and described in U.S. Pat. No. 6,374,684, entitled “Fluid Control and Processing System” filed Aug. 25, 2000, and U.S. Pat. No. 8,048,386, entitled “Fluid Processing and Control,” filed Feb. 25, 2002, the entire contents of which are incorporated herein by reference in their entirety for all purposes.

Various aspects of the biochip cartridge 100 shown in FIG. 1 can be further understood by referring to U.S. Pat. No. 6,374,684, which describes certain aspects of the sample cartridge in greater detail. Such sample cartridges can include a fluid control mechanism, such as a rotary fluid control valve, that is connected to the chambers of the sample cartridge. Rotation of the rotary fluid control valve permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module comprises a motor such as a stepper motor that is typically coupled to a drive train that engages with a feature of the valve in the sample cartridge to control movement of the valve and resulting movement of the fluid sample according to the desired sample preparation protocol. Fluid metering and distribution functions of the rotary valve can be utilized and controlled to perform a particular sample preparation protocol.

It is appreciated that the sample cartridge described above is but one example of a sample processing device suitable for use with the chip carrier devices in accordance with embodiments described herein. While chip carrier configurations that allow for use of such a sample cartridge are particularly advantageous as they allow utilization of existing sample cartridges and sample processing devices, it is appreciated that the concepts described herein in regard to the chip design can be applied to other sample processing devices, for example, the dual piston rotary valve device described in U.S. Pat. No. 7,032,605, incorporated herein by reference. It is further appreciated that the chip designs described herein can be configured to be compatible with various other chip carrier devices, sample cartridge configurations or other fluid sample processing devices and components, for example, any of those described in U.S. Provisional Application No. 62/734,079 filed Sep. 20, 2018, incorporated herein by reference.

### D. Instrument Interface

As shown in FIG. 2, the analytical testing system 200 includes one or more modules 210, that each includes an instrument interface 216 to facilitate powering/communication/optical detection of the chip. The instrument interface 216 can include a circuit board adapted to engage an electrical interface of the chip device to allow the module to electrically power, control and communicate with the chip device, as well as an optical detection unit to detect fluorescence from the active face of the chip. In some embodiments, the instrument interface is located within a receiving bay 211 of the module 210 to provide more seamless processing between the sample cartridge and the chip device. The instrument interface can be controlled by the module in coordination with transport of the fluid sample from the sample cartridge to the chip.

In one aspect, the instrument interface 216 includes electrical contacts 217 (e.g. probe contacts) that engage corresponding contacts on the chip. The instrument interface board can be configured to move or pivot from an open position before the sample cartridge is loaded to an engaged position when loaded. A cam (not shown) positions the interface board so that the probes contact the electrical interface of the chip device. The probe contacts can be pogo pins on the instrument interface board that contact corresponding probe contact pads on the electrical interface of the chip device to allow the module to control analysis of the fluid sample with the chip. The instrument interface can also host passive and active electronic components in addition to those of the chip carrier as needed for various other tasks. For example, such components could include any components needed for signal integrity, amplification, multiplexing or other such tasks.

In another aspect, the instrument interface 216 can further include an optical unit 218 configured for excitation and/or detection. In some embodiments, the optical unit can be configured for detecting fluorescence from the active surface of the diagnostic chip. The optical detector can include one or more photodetectors, such as CMOS or CCD sensors. In some embodiments, the photo-diode detectors can be incorporated into the chip and the optical unit provides excitation flux to the diagnostic chip.

### E. Example Systems

FIG. 2 illustrates an overview of a system 200 utilizing a conventional sample cartridge 110 fluidically coupled with a chip carrier device 10. The sample cartridge is adapted for processing within a sample processing system 200. Some conventional sample cartridges were configured for coupling with a reaction vessel having a distal reaction chamber for detection of a target analyte by a PCR reaction using optical excitation/detection. This chip carrier device 10 can fluidically couple to the cartridge in substantially the same manner, however, fluidic paths within the chip carrier device 10 transport the prepared fluid sample into a distal flowcell chamber that interfaces with a major active surface of a diagnostic chip supported in the chip carrier device 10. The chip carrier device supports the diagnostic chip therein, and scalingly engaged against the active surface of the diagnostic chip, while multiple electrical contacts of the chip remain accessible to allow operation and detection with the chip through the instrument interface electrically coupled thereto. In this embodiment, the chip carrier device 10 extends at least a distance d from the cartridge, as shown in FIG. 1, so that the distal chip carrying portion 30 can be positioned distally to accommodate the instrument interface and optical detection unit, which may be larger than the optical detection unit typically used for a conventional reaction vessels. In some embodiment, the distance d can be at 5-7 cm or more. In some embodiments, the distance d is about 2.2-4.2 cm, typically about 2.5 cm. It is appreciated that this portion may extend various differing lengths as needed to accommodate interfacing components.

As shown in FIG. 2, the biochip cartridge 100 is configured for insertion into a bay 211 of a sample processing module 210 of the system and is enclosed in the bay by door 212. The bay 211 is configured to perform one or more processing steps on a fluid sample contained within the sample cartridge through manipulation of the sample cartridge by one or more mechanisms 214 within the bay. Instrument interface 216 of the module is incorporated within the bay and facilitates operation and testing with the diagnostic chip supported within the chip carrier device 10. The instrument interface 216 includes an instrument board, such as a PCB board, that extends alongside a major planar surface of the chip carried within the carrier device 10 and includes electrical contacts 217 arranged so as to electrically couple with corresponding probe contact pads on the major planar surface of the chip and further includes an optical unit 218, which can include an excitation means and/or a detection means to sense fluorescence from the active surface of the chip. The system 200 can include multiple modules 210 of like construction, or differing types of modules. In some embodiments, the system includes differing types of modules, such as module 210 that is configured to process a cartridge with an attached chip carrier device, and module 210′ that is configured to process a cartridge with an attached conventional PCR reaction vessel. In other embodiments, the system can include a module that is configured to perform processing of both conventional PCR reaction vessels and diagnostic chips supported in chip carrier device.

The instrument interface 216 of the module includes electrical contacts 217 for interfacing with electrical contact pads 33 of the chip device. Typically, the contacts are arranged in a pattern, such as a linear or rectangular array, that corresponds to the contacts of the chip device. In this embodiment, the contacts can be configured as pogo-pins so as to deflect upon insertion of the chip carrier device 10 into the bay to provide secure electrical coupling between probe contacts 33 of the chip and corresponding probe contacts 217 on the instrument interface, as shown in FIG. 2. Although a linear array of pogo-pins is depicted here, it is appreciated that the electrical contacts could be arranged in various other patterns, in accordance with a corresponding chip carrier device and that various other contact constructions could be realized. In some embodiments, the electrical contacts could be configured as one or more edge connectors or other types of multi-pin connector arrangements. It is further appreciated that the instrument interface need not utilize every contact so as to be compatible for use with a chip carrier device having differing numbers or arrangements of contact pads, as desired. In some embodiments, the electrical contacts could include an additional adapter so as to be suitable for use with various differing types of chip carrier devices. In some embodiments, it may be cost effective to package a semiconductor controller as an adjunct to the chip carrier device such that the signal connectivity is minimized. Such an approach could use any suitable connector means, which can include a standard connector type, such as a USB interface (e.g. [+1, −2, sig 3, sig 4]).

E. Example Chip Carrier devices

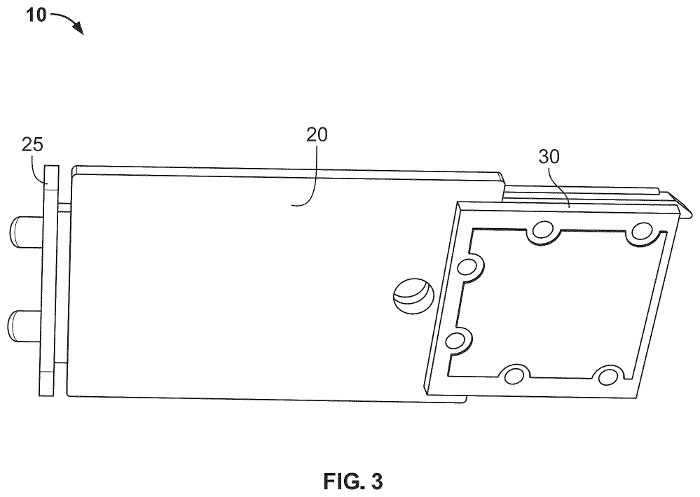

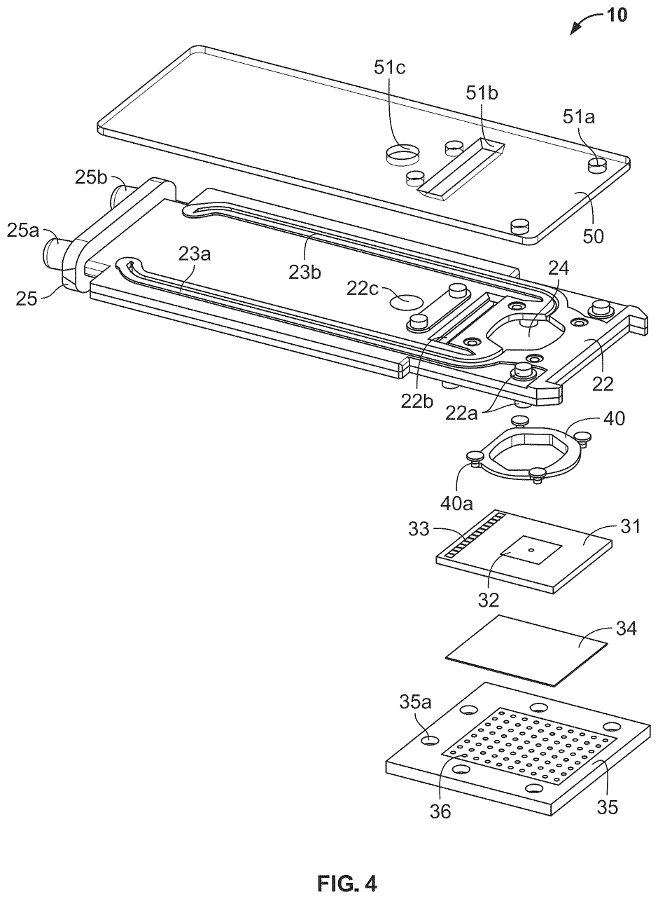

FIG. 3 illustrates a detailed view of the chip carrier device 10 with integrated fluid flow control, in accordance with some embodiments. Typically, the chip carrier device 10 is a planar device having an elongated fluid transport portion 20 with one or more fluid flow channels that transport the prepared fluid sample to a distal chip carrying portion 30 that supports a diagnostic chip and includes a flowcell sealingly engaged against the active area of the chip. At a proximal end thereof, the chip carrier device 10 includes a fluidic interface 25 for fluidically coupling to the sample cartridge 110. The chip carrier device can be formed from a suitably rigid material such that the chip carrier device 10 extends outward from the sample cartridge 110, which allows clearance for various other components, such as the instrument interface of the module and/or thermal cycling units. The various components and features of the chip carrier device 10 can be further understood by referring to the exploded views and side views in FIGS. 4-6B.

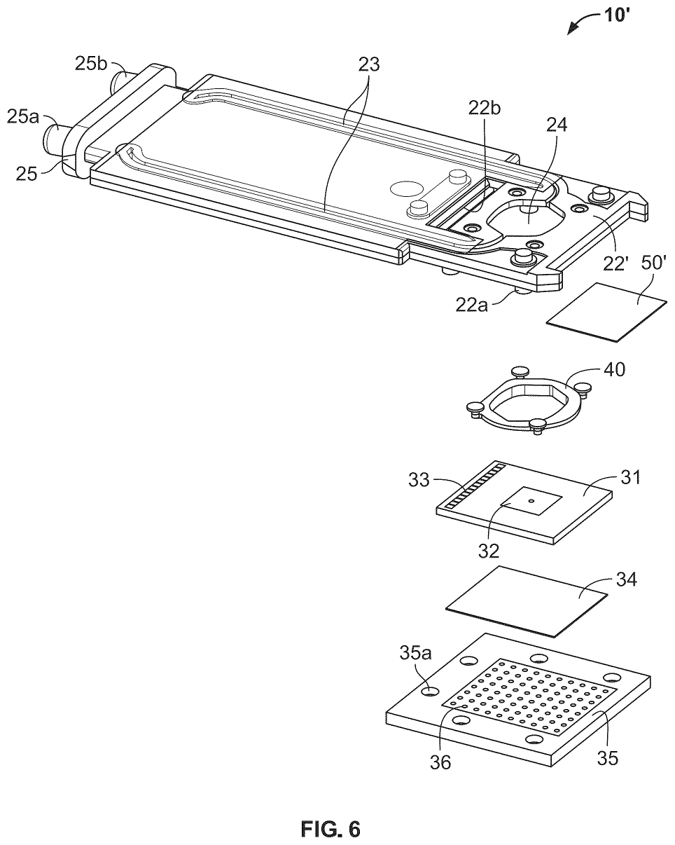

As detailed in FIGS. 4 and 6, the chip carrier devices 10, 10 include a frame 22 with a fluidic interface 25 at a proximal end thereof configured with fluid ports 25a, 25b (e.g. Luer type ports) and a flange arrangement that is the same or similar as that of a typical PCR reaction tube so that the fluid sample adapter can interface with existing sample cartridges, as described previously. It is appreciated however that various other types of fluid ports (e.g. Luer type ports, pressure fit, friction fit, snap-fit, click-fit, screw-type connectors, etc.) in various other arrangements could be used. In these embodiments, when the device is vertically oriented, the lower fluid port 25a is a fluidic inlet and the upper fluid port 25b. By controlled application of pressure through the sample cartridge, the prepared fluid sample is transported through the fluidic channels to a flowcell 24 in the distal chip carrying portion 30.

Typically, the fluidic pathways are defined in a first substrate (e.g. the frame) and sealed by a second substrate, such as a lid or thin film, similar to the construction of conventional PCR reaction tubes. In some embodiments, the frame also features alignment and assembly bosses as well as mechanical snaps to facilitate assembly of components as well as a contoured region shaped to fit the chip so that the chip can be easily aligned and secured against the flowcell. In some embodiments, the chip carrier device includes one or more channels that extend between fluid-tight couplings without any chambers, valves or ports between the proximal and distal ends. In other embodiments, the device includes one or more valves, or ports. In some embodiments, the one or more channels can include one or more chambers or regions, which can be used to process or analyze the fluidic sample, for example, chambers or regions for thermal amplification of a nucleic acid target, filtration of the sample, chromatographic separation of the sample, hybridization, and/or incubation of the sample with one or more assay reagents.

As can be seen in the exploded view of FIG. 4, the chip carrier device 10 includes an optical lid 21 disposed atop a frame 22, a gasket 40, a diagnostic chip 31, a thermal contact sheet 34 and a PCB 35. In this embodiment, the PCB is not electrically coupled, but relies on multiple through-vias for heat dissipation. Thus, the heat dissipation is ‘tunable’ according to the density and size of the vias being used. It is appreciated that various other approaches to heat dissipation can be used, and that the PCB could be replaced with various differing types of substrates. The lid 21 is formed of a transparent or translucent material (e.g. glass or polymer, such as Zeon 1420R COP) and is fluidically sealed to the frame. The top lid can be sealed to the frame by laser or ultrasonic welding, or any suitable means. The frame includes fluid flow channels defined therein, such that the frame and lid together act as first and second substrates enclosing the fluid flow channels and flowcell of the device. The lid is transparent so as to act as an optical window to allow fluorescence detection of the active surface of the diagnostic chip. The lid can include coupling features 21a, which interface with corresponding components of the frame 22 to facilitate alignment and coupling with the frame. Hole 51c can be utilized to aid in manufacturing and assembly fixturing, and can optionally be used as an additional location or alignment feature for the instrument.

The access openings 51b allow the contacts 33 of the chip 31 to be accessed by the contact pins of the instrument interface from one side of the device. The frame 22 can be formed of any suitable material, typically a polymer (e.g. Zeon 1420R COP) and includes corresponding alignment/mating features 22a for coupling with the lid on one side and the PCB on the opposite side. The fluidic interface 25 is disposed at a proximal end and includes fluidic inlet 25a and fluidic outlet 25b, which correspond to the fluid flow paths, the inlet channel 23a and outlet channel 23b. It should be understood that use of the terms “inlet” and “outlet” do not limit function of any fluid inlets or outlets described herein. Fluid can be introduced and evacuated from both or either. In this embodiment, the fluid flow paths lead to/from a flow cell cavity 24, which partly defines (along with the lid and gasket) the flowcell against the active area 32 of the diagnostic chip. The gasket further includes mating features 40a that facilitate alignment/coupling with corresponding features in the frame 22. It is noted that these features can be formed during the overmolding process such that the features are formed within corresponding recesses within the frame. In some embodiments, the frame 22 and gasket 50 are defined so that the volume of fluid sample transported therethrough is similar to production of a 50 μl reaction tube so as to be compatible with a conventional sample cartridge. In this embodiment, the overmold gasket 50 is designed as a single lip seal design that is between 500 μm and 1,000 μm thick (e.g. 750 μm) and mechanically interlocks with the frame so as to form a suitably sized flowcell adjacent the chip. The gasket is formed of a compliant material (e.g. thermoplastic rubber, Infuse 9807) to promote scaling engagement with the frame and chip when assembled. The thermal sheet 34 forms a thermal contact between the diagnostic chip 31 and PCB 35. In this embodiment, the thermal sheet 34 is formed of graphite (e.g. Panasonic PGS) and is of a suitable thickness (e.g., 100 μm), although any suitable material can be used. The PCB 35 provides additional thermal control by thermal region 36 which is a region having multiple through-vias, the density and size of which controls the thermal conductivity of the interface so that thermal resistance can be controlled. The thermal resistance of the thermal region is designed so that the heat dissipation doesn't ‘outrun’ the ability of the resistive heaters on the chip to both heat the liquid and deal with dissipative losses through the silicon substrate. The PCB also retains the diagnostic chip on the frame. PCB 35 can be coupled to the frame via heat staking of frame posts through coupling/mating holes 35a, or by any suitable means.

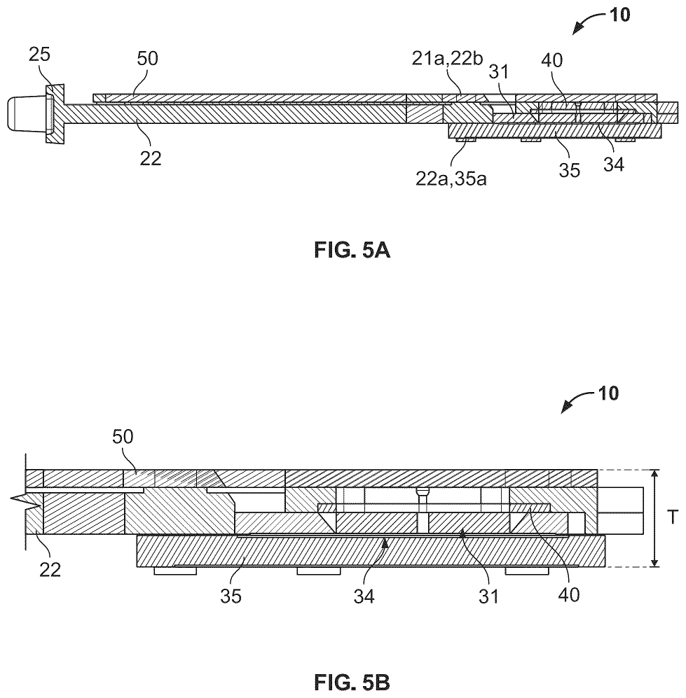

FIGS. 5A-5B illustrate side views of the chip carrier device 10 that show the thickness and stacking of various layers when assembled. As shown in FIG. 5A, the lid 50 is scaled atop the frame 22 by heat staking mating features 51a, 22a. The gasket 40 is overmolded so as to be sealingly coupled with the frame, thereby defining flowcell chamber 24 disposed along the active surface of the diagnostic chip 31. The chip is securely held in place between the frame 22 and the PCB 35. The PCB 35 is secured to the frame 22 by heat staking corresponding coupling/mating features 22a, 35a. Thermal contact sheet 34 is disposed between the PCB and chip. The relative thickness of each layer/component of this embodiment can be understood by referring to FIG. 5B. In this embodiment, the total thickness of the chip carrier device 10 is about 3.75 mm; the lid is about 0.7 mm thick; the frame is about 1.8 mm thick, the diagnostic chip 31 is about 0.75 mm thick; the graphite sheet is about 0.1 mm thick; and the PCB is about 1.2 mm thick. It is appreciated that these dimensions are exemplary and that various other dimensions could be realized.

While a particular assembly is shown here, it is appreciated that the chip carrier device can be formed as an integral component, certain components could be combined or assembled from multiple components, or that the device could incorporate various other features (e.g. valve, filter). In some embodiments, the chip carrier device (or at least a partial assembly) is provided pre-attached to a sample cartridge with the fluid-tight couplings coupled with corresponding fluid ports of the cartridge and pre-attached to the diagnostic chip. In other embodiments, a sample cartridge may be provided already coupled with the chip carrier device such that an end-user can insert any chip within the chip carrier device 200 against the flowcell chamber to facilitate sample detection with a chip.

In another aspect, the frame and fluidic channels can be formed within an integral component and the window to the active area of the diagnostic chip can be formed as an insert or molded into the frame. This approach allows the window to be formed of any suitable transparent material, including materials such as glass. Glass provides superior optics, as compared to polymer window used in conventional devices, which allows for certain advantages. For example, the glass window can include a filter layer, thereby obviating the need for a filter on the diagnostic chip itself. It is appreciated that the viability of these features depends on the design of the diagnostic chip being used. This approach also facilitates integration of other surface features further improving performance of the diagnostic chip, which allows the diagnostic chips to be smaller, lighter, and easier to manufacture. For example, in some embodiments, the coated glass window can have a chemical vapor despoition (CVD) metal aperture such as a chromium or aluminum deposition made on glass using lithographic techniques (i.e., using a photoresist mask layer, which is fixed and washed, so that certain areas of the glass surface are masked off). Then, the CVD process is used to deposit a very thin layer of metal on the surface metal does not let light pass, which typically utilizes a vacuum chamber where a carbon electrode is located near a deposition metal electrode and a high voltage arc is created which vaporizes the metal, which recondenses on nearby surfaces. The photoresist mask is then chemically removed leaving the metal deposit layer. This approach is useful for glass scale encoders and other optics that require sharp edge cutoffs that reduce any chance of light scatter. Since glass bonds well to the frame materials (e.g. silicone), potential issues in regard to compression setting can be avoided. An example of such an embodiment including a glass window is shown in FIG. 6.

FIG. 6 shows an exploded view of a chip carrier device 10′ having a frame 22′ with a glass window 50′ that is molded or inlaid within. Similar to the previous embodiment, the frame 22′ includes a fluidic interface 25 at a proximal end thereof, fluidic channels 23 extending between the fluidic interface 25 and the flowcell cavity 24, a gasket 40 that attaches to the frame and seals about the active surface 32 of the diagnostic chip 31, a thermal contact sheet 34 and a PCB 35 so as to securely hold the diagnostic chip 31 within the assembly. The device include same or similar features as the previous embodiment in regard to alignment and mating/coupling features. Since the window is only required adjacent the active surface of the diagnostic chip 31, the fluidic channels in the frame can be integrally formed with the frame (e.g. by pins in injection mold). The frame includes a rectangular access opening 22b that allows access to the contacts 33 along the diagnostic chip for operation and/or detection with the diagnostic chip by the instrument interface.

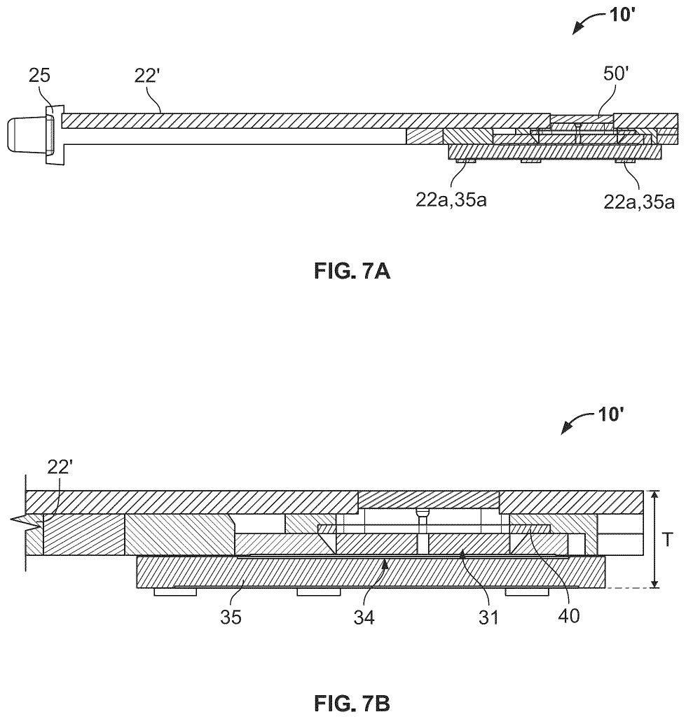

FIGS. 7A-7B illustrate side view of the chip carrier device 10 that shows the thickness and stacking of various layers when assembled. As shown in FIG. 7A, the glass window 50′ is inlaid or molded within the frame 22′. The gasket 40 is scalingly coupled with the frame and glass window about flowcell chamber 24 adjacent the active surface of the diagnostic chip 31, which is securely held in place between the PCB 35 and frame 22′. Thermal contact sheet 34 disposed between PCB 35 and chip. The PCB 35 can be secured to the frame 22 by heat staking corresponding coupling/mating features 22a, 35a or any suitable means. The relative thickness of each layer/component can be understood by referring to FIG. 7B. In this embodiment, the total thickness of the chip carrier device 10 is about 3.75 mm; the glass window is about 0.7 mm thick; the frame is about 2.5 mm thick, the diagnostic chip 31 is about 0.75 mm thick; the graphite sheet is about 0.1 mm thick; and the PCB is about 1.2 mm thick. The thermal contact sheet is optional depending on desired parameters and, in many embodiments, the thermal contact sheet can be removed entirely from the assembly. It is appreciated that these dimensions are exemplary and that various other dimensions could be realized.

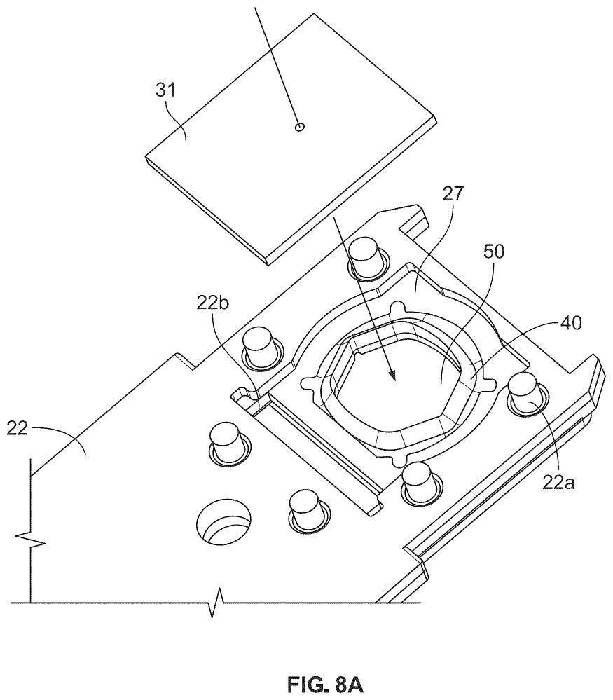

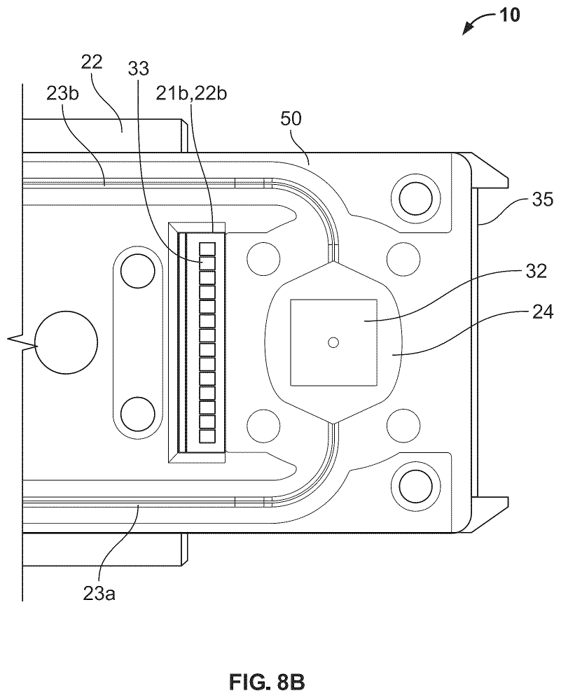

FIG. 8A shows a back side view during assembly of the chip with the chip carrier device. The chip carrier device frame 21 includes a contoured region 27 dimensioned to receive the diagnostic chip 31 within. The contoured region can include a raised ridge along the perimeter thereof to engage edges of the diagnostic chip so as to align the chip within the chip carrier device with the active surface of the chip positioned adjacent the flowcell. The flowcell is defined by the gasket 40, frame and window, which allows for optical detection of the active surface by the instrument interface. While this embodiment shows a top lid 21 that defines the window, it is appreciated that this same approach can be used in the design of FIG. 6 having a glass window that is molded or inlaid within the frame.

FIG. 8B shows a front side view of the assembled chip device 10, the components described above assembled so that the flowcell 24, which is defined by the frame 22 and gasket, is sealed against the active surface 32 of the diagnostic chip. As shown, the access openings 51b, 22b (e.g. pogo window) in the lid 21 and frame 22, respectively, are aligned so that the electrical contacts 33 (e.g. chip I/O pads) of the chip 33 are accessible by the instrument interface contacts (e.g. by pogo pins). In this embodiment, the transparent lid 21 provides a window that exposes about 4 mm² array of the active surface 32 to facilitate optical excitation by the instrument interface (e.g. LED instrument). In this embodiment, the chip includes the optical detector for optical detection of the fluorescence from the excitation. It is appreciated that various other chip configurations can be designed for various other arrangements of features (e.g. on-board and off-board) in regard to optical excitation and/or detection.

It is appreciated that the chip carrier device with integrated fluid control can include any of the features or structures described herein, or any of those described in U.S. Provisional Application No. 62/734,079 filed Sep. 20, 2018.

### II. Fabrication Methods

In one aspect, chip carrier devices with overmolded gaskets and integrated designs that incorporate a glass window are described herein. These designs can be fabricated by use of specially designed injection molds and overmolding, as described further below.

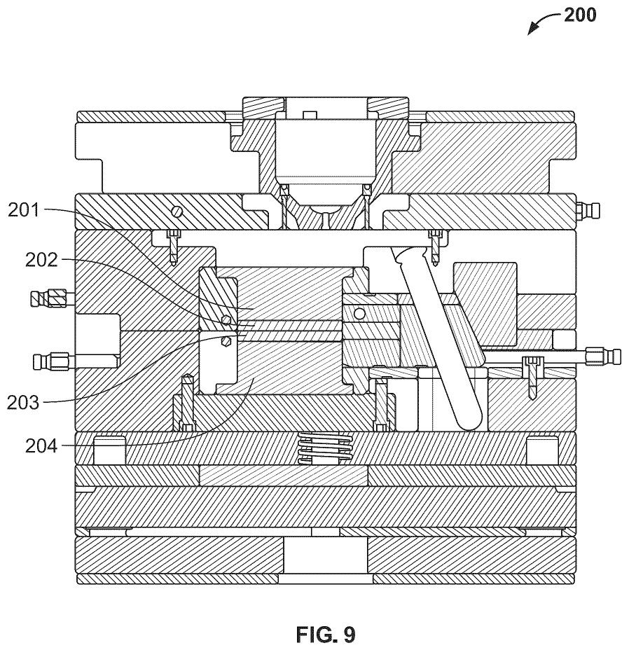

FIG. 9 shows an exemplary frame and overmold tool that can be used for molding of the frame 22, the overmolded gasket. In accordance with injection molded systems, the tool includes a top plate assembly 201 that facilitates injection molding into the frame cavity mold 202 to form the frame, and a bottom plate assembly 204 that facilitates injection of thermoplastic rubber into the overmold cavity mold 203 to form the gasket.

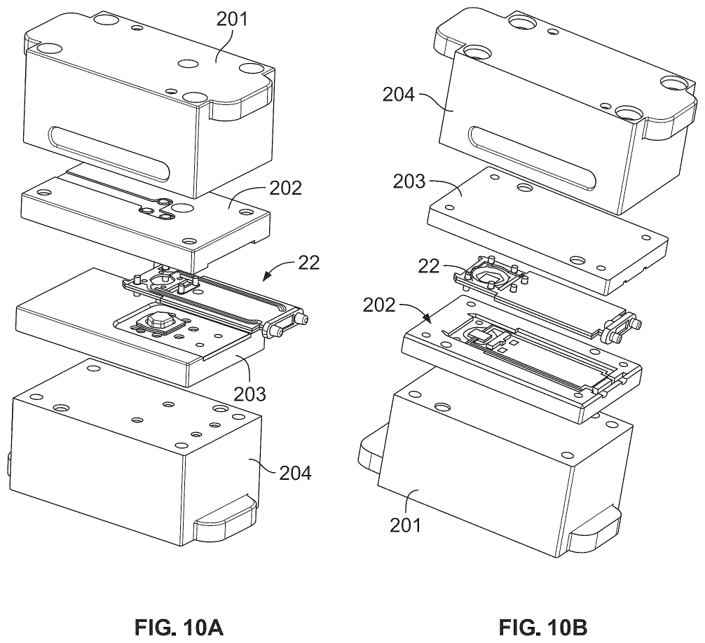

FIGS. 10A-10B show detail views of the components of the frame mold 202 and the overmold cavity mold 203. This approach both forms the frame and forms the gasket overmolded with the frame so that the frame is securely and scalingly attached. Both the frame and gasket use the same blank sets of cavity plates, which simplifies the required mold components and improves case and efficiency of manufacturing. Further, the use of laminated cavity sets allow for quick design and cavity changes as needed. While the mold setup here is configured to form frame 22, as shown in FIG. 4, it is appreciated that the molds can be modified to form the frame with additional integral components or to form variations of the frame as discussed herein. In other embodiments, various other approaches or additional mold configurations could be used to form the components.

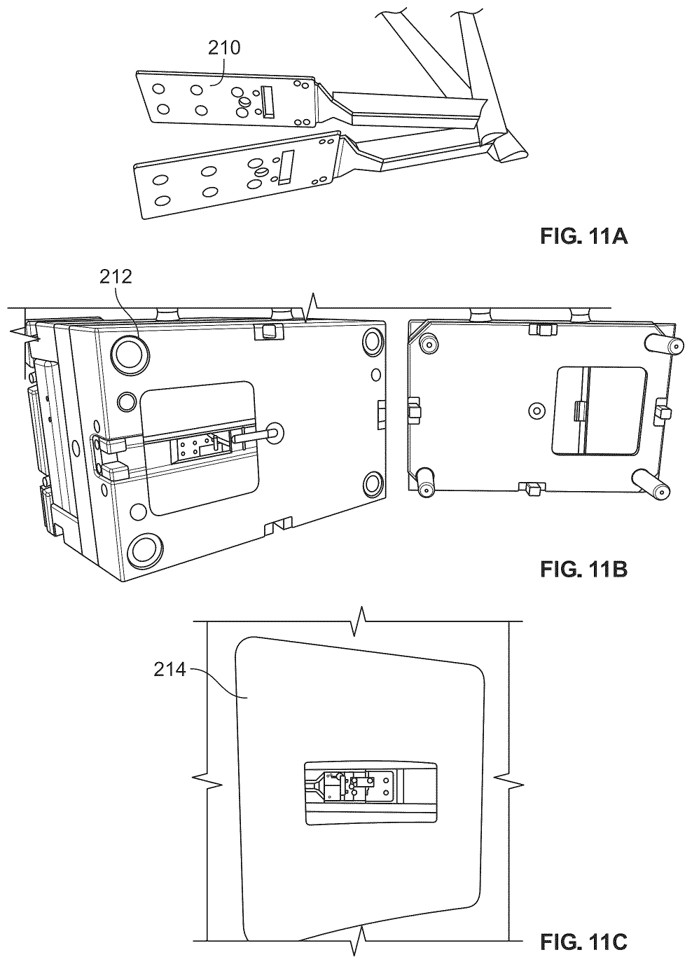

FIGS. 11A-11C show custom injection molding components configured for manufacturing components of the chip carrier devices described herein. FIG. 11A shows a cavity insert 210 that can be used to adjust the cavity to achieve changes in part thickness in forming the lid component. FIG. 11B shows custom mold base 212 configured to form the frame. The base is designed for use with heater rods along the injection ports so as to promote thin wall molding and improve efficiency in molding. The base can be further designed with a nitrogen port on the molding machine barrel to maintain part clarity. FIG. 11C shows the mold cavity and core retainer blocks 214. The blocks can be made of any suitable material, including aluminum or steel (e.g. A2 tool steel). The blocks can be made with accommodations for heater rods so as to achieve a thin (e.g. about 0.7 mm) molded lid. The mold cavity inserts can be made of any suitable material, including aluminum or steel (e.g. M390 stainless steel). The molding surfaces are diamond polished (e.g. polished with a finishing 1.0 mesh) to achieve an A1 surface finish.

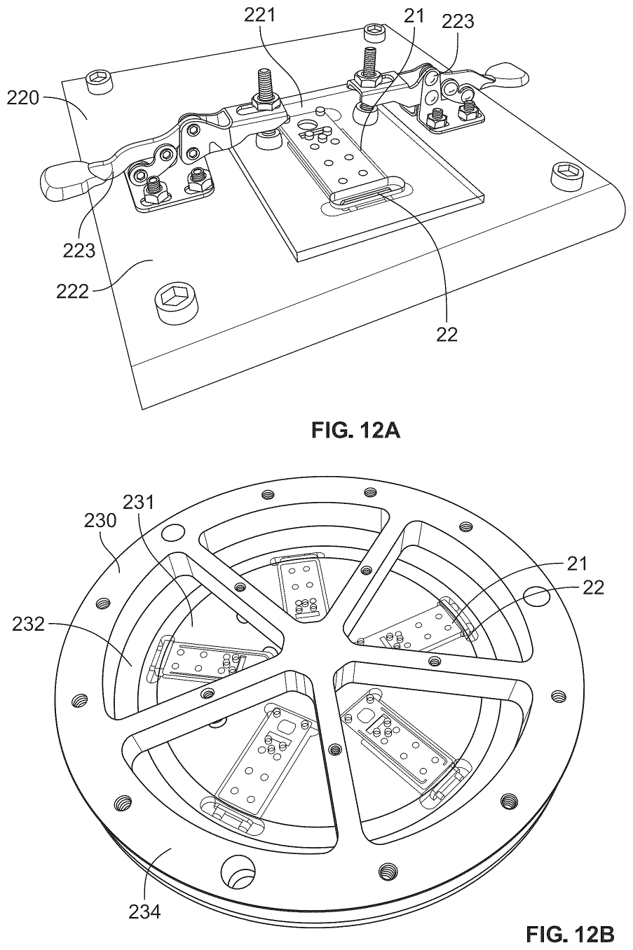

In one aspect, the device uses a laser welder to attach a polymer lid to a polymer frame to meet required optical specifications and to seal the fluid paths defined in the frame. FIG. 12A shows a compression fixture 220 configured to perform this laser welding operation between the lid 21 and frame 22. The fixture 220 includes a clear compression plate 221 that compresses the lid/frame assembly toward a bottom plate 222 by two adjustable clamps 223. As shown, the frame is doped black to serve as an absorptive layer and the frame is configured with an elevated weld track along the periphery. The clear frame of the fixture allows for transmission of the laser beam to weld the surface. The fixture is constructed as a temporary stage to provide clamping force between the lid and frame. FIG. 12B shows another approach of a laser weld compression nest fixture 230 that allows for welding of multiple devices simultaneously. The fixture includes a compression plate 231 that compresses multiple lid/frame assemblies toward a bottom plate 232. The top plate interfaces with a circular frame 234 having multiple sections (e.g. five sections) to allow for concurrent welding of multiple lid/frame assemblies. In this embodiment, the fixture design can pneumatically provide a suitable compression force (e.g. 150 lbf) between the lids and frame next and uses a glass or acrylic as the compression plate.

In another aspect, the chip carrier device utilizes the PCB as a retaining component, holding the chip in compression against the overmold gasket within the frame. In some embodiments, the connection of the PCB is performed by heat staking of frame posts to the frame. Countersinks in the PCB component lock it in place after assembly. This can be performed by specially configuring a conventional press (e.g. Janesville press, EC-66 with QuaRC build custom die) in order to perform repeateable heat staking. This can achieve suitable compression levels (e.g. 396 lbf compression). A preload button can be used to provide about a preload force (e.g. 5 lbf) prior to staking, and the heat staking rods can be performed at a suitable elevated temperature (e.g. 300 degrees F.). This approach is able to achieve sub-flush staked posts on consumable required for thermal contact with instrument. The PCB includes a thermal region that includes an array of through-vias (e.g rectangular array of 80 vias), which conduct thermal energy so as to improve consistent temperature across the chip to either dissipate heat generated during operation of the chip and/or to facilitate controlled thermal cycling. It is appreciated that this component can instead be a substrate without any through-vias, with an alternative thermal control means (e.g. active or passive), or without any thermal control means.

In yet another aspect, the chip carrier device is design so that the fluid flow channels (inlet channel/outlet channel) and flowcell chamber have volumes corresponding to the attached sample chamber and operation thereof. In some embodiments, the flow channels and flowcell chamber are configured with volumes so that the cartridge can operate fluid flow of the prepared fluid sample by the same or similar protocols as is used with conventional reaction vessels. This is advantageous as it allows the substanitally the same operating protocol or a similar protocol to be used in controlling operation of the chip carrier device, including outflow of prepared fluid sample to the flowcell. In other embodiments, the system can utilize an entirely different protocol to faciltiate fluid flow through the chip carrier device to meet the flow requirements for a given diagnostic chip.

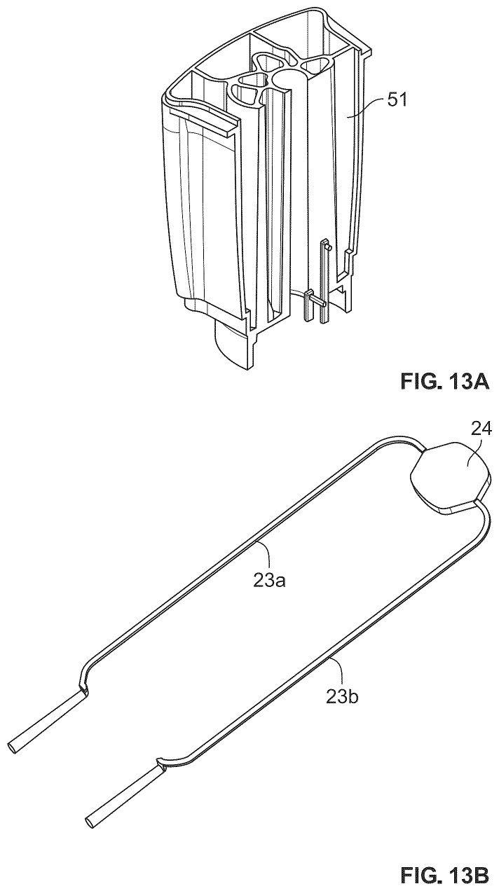

As shown in FIG. 13A, a conventional sample cartridge body 51 has an internal cartridge volume, which in one conventional sample cartridge design is 11.8 mL. Accordingly, for the reaction tube (as shown in FIG. 13B), each of the inlet channel and outlet channels 23a, 23b can be configured with a total volume of 21.8 μl and the flowcell chamber (defined by the frame cavity and overmolded gasket) can be configured with a reaction volume of 41 μl. These volumes ensure that the amount of prepared fluid sample delivered to the flowcell meets the required chip volume requirements. In some embodiments, this volume requirement is at least 37.5 μl. In some embodiments, the chip carrier device is configured to provide a reaction volume between 25-100 uL, preferably between 35-50 uL, depending on the diagnostic chip.

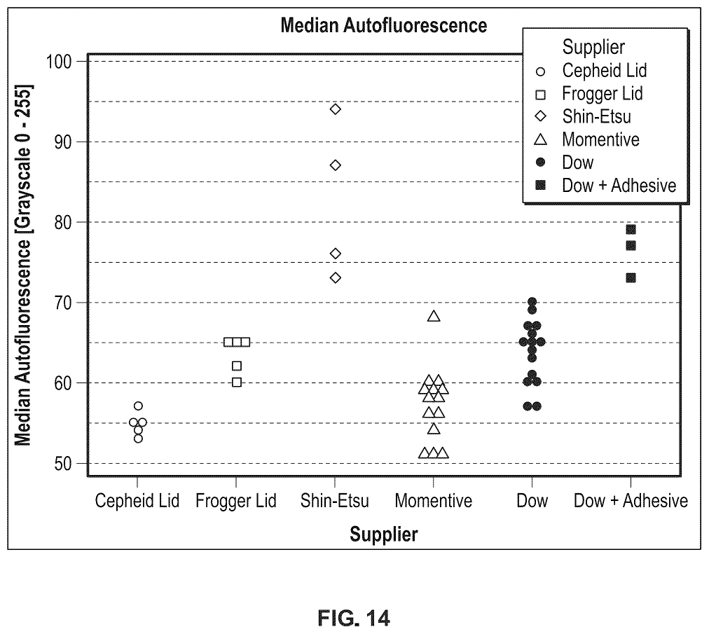

As benchtop testing indicated, shown in FIG. 14, the chip carrier device demonstrated a range of optical properties depending on the properties of the lid material and means of attachment. Preferably, the optical lid material is formed of a material with properties at or approaching zero autofluorescence at the excitation frequency, 100% optical transmission (i.e., clarity), zero optical scatter, high thermal conductivity, easy mold processability, low cost, and the ability to easily and hermetically join the lid to the frame. As shown in the embodiment in FIG. 14, the image intensity was threshold to 50 prior to calculating median intensity.

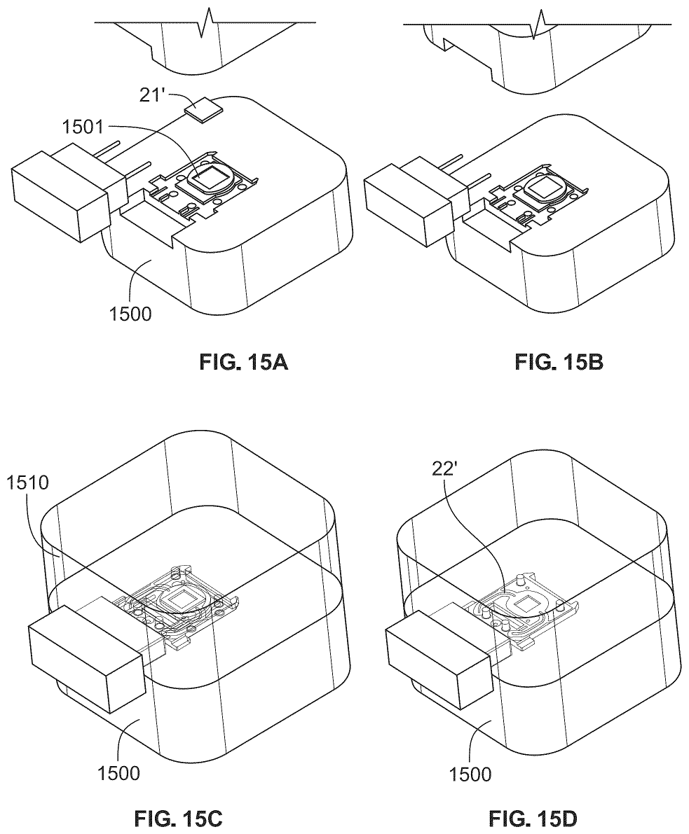

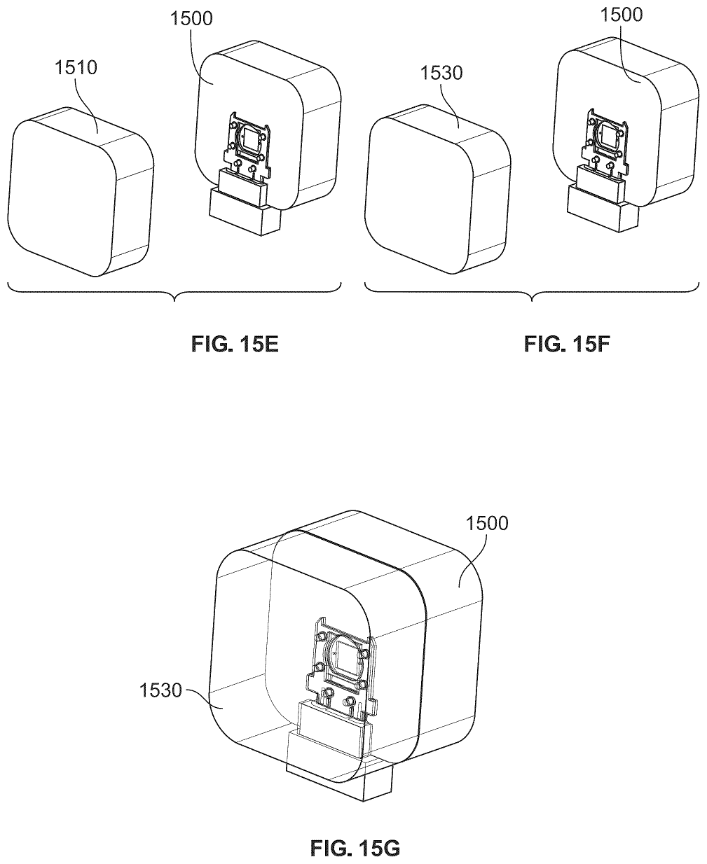

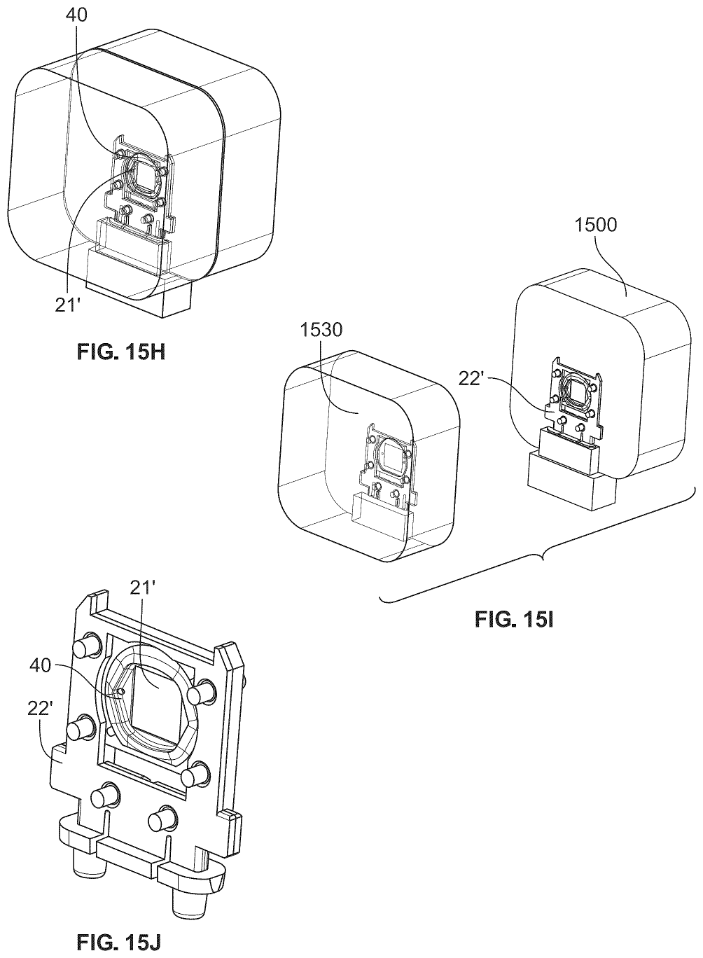

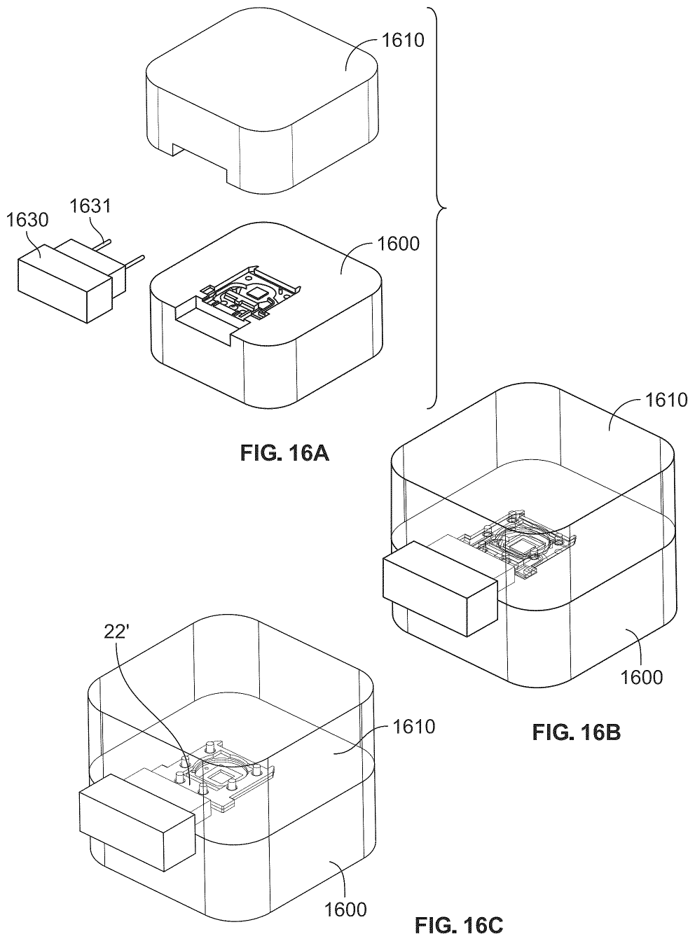

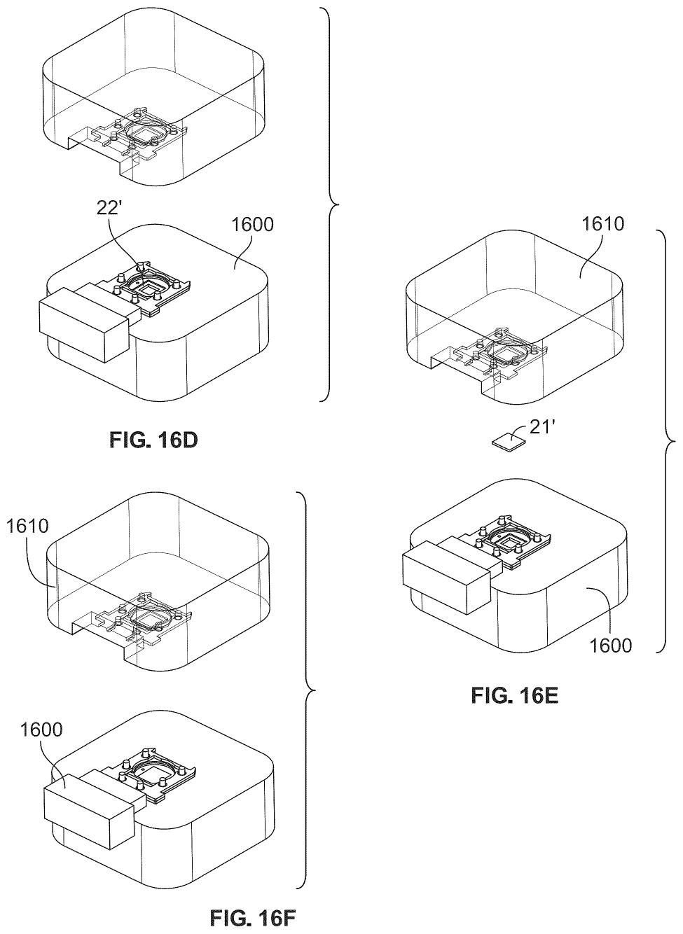

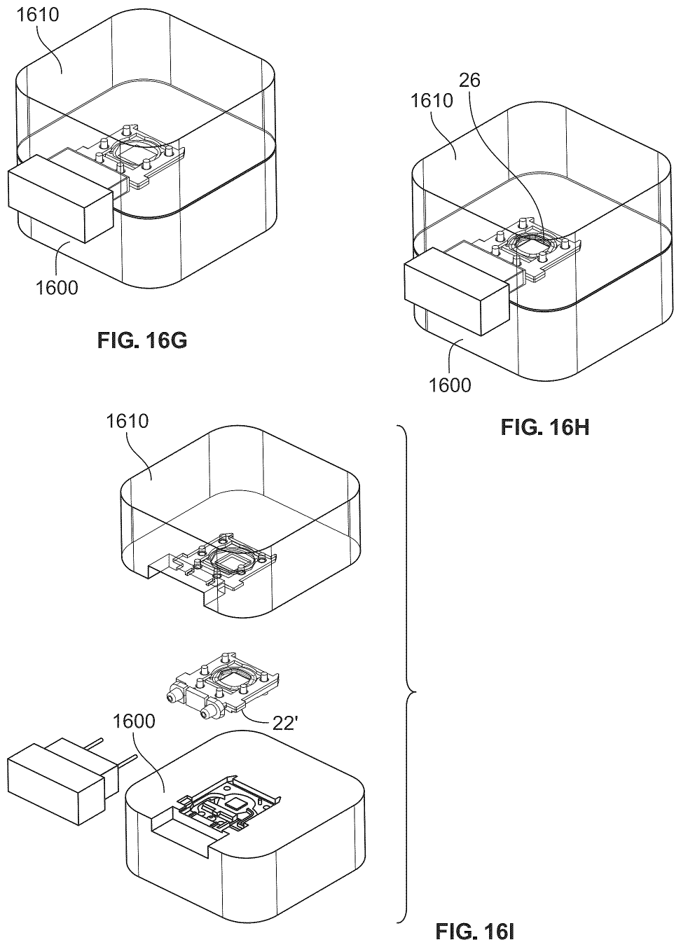

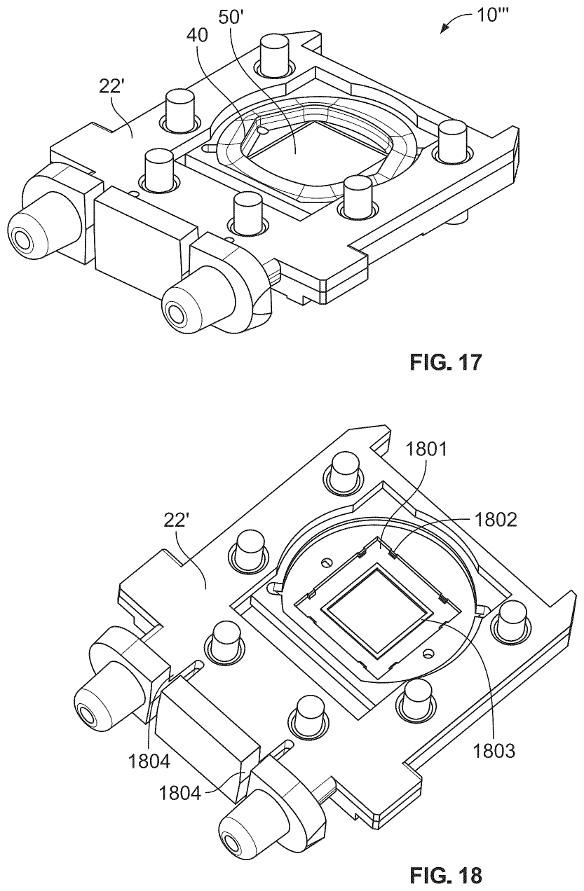

As shown above, the optical properties of the transparent optical lid can vary greatly depending on the optical lid materials and means of attached to the frame. In some embodiments, the optical properties of the transparent window to the active surface of the chip can be further improved by utilizing a glass window that is molded or inlaid into the frame. Such an improvement represents marked advantages including superior optics and improved performance. This also allows for integration of surface features (e.g. filters, coated glass with a chemical vapor deposition metal aperture) so that the features are no longer required to be formed within the chip. This streamlines the production of the diagnostic chip. Further, this approach avoids drawbacks associated with manufacture and attachment of a transparent lid, and avoid compression set issues since the glass bonds well to the polymer frame. Methods of incorporating a glass window into the frame assembly are detailed further in FIGS. 15A-15J and 16A-I.

FIGS. 15A-15J detail a first appraoch of incorporating a glass window in the chip carrier device. First, the method entails placing a precut piece of glass as the optical window 50′ in a molding tool half 1500 of the injection molding press, as shown in FIGS. 15A-15B. If the glass window doesn't stay in the pocket 1501, a port can be included in the clamping face so that a vacuum can be drawn to hold the glass window in the position shown. Next, the tool is closed against the opposing molding tool half 1510, as shown in FIG. 15C, and thermoplastic resin is injected into the mold to form the frame 22′ around the glass window insert, as shown in FIG. 15D. After the molded frame is formed, the tool is opened, as shown in FIG. 15E, and the tool half 1501 holding the frame with glass insert is positioned at the overmold station with an overmold tool set half 1530, as shown in FIG. 15F for formation of the overmold gasket. In some embodiments, the tooling is at least partly automated such that after the frame is molded, the mold half containing the frame is indexed to a station that places the glass in position, and tooling closes to create the elastomeric gasket component. As shown in FIG. 15G, the tool is closed with the overmold tool side onto the base mold. As shown in FIG. 15H, thermoplastic rubber is injected an overmolded with the frame over the periphery of the glass window insert and the frame to form gasket 40. The gasket can include coupling/mating features within the frame that securely attached the gasket with the frame and sealingly engaged with the glass window insert. As shown in FIG. 15I, the tool is opened and removed and the piece is ejected. The resulting overmolded frame with glass window insert is shown in FIG. 15J.

FIGS. 16A-16I detail a second approach. First, the molding tool is closed. The molding tools includes the molding base half 1600 having the frame cavity, the top molding half 1610 for the overmold, and the fluidic interface mold 1630 having pins 1631 defining the fluidic inlet/outlets. When closed, the molded halves form the cavity for forming the frame, as shown in FIGS. 16A-16B. The frame is molded by injecting thermoplastic resin into the mold to form the frame 22′, as shown in FIG. 16C. In some embodiments, the tool is opened, the part ejected, then the glass window is inserted into the frame and then placed into the overmold half. In other embodiments, such as shown in FIGS. 16D-16F, the tool is opened, the glass window 50′ is loaded into the frame in-situ within the mold base 1600 (as shown in FIG. 16E), and positioned to the overmold station as shown in FIG. 16F. The tool is then closed, as shown in FIG. 16G, and a thermoset or thermoplastic (e.g. liquid silicon rubber (LSR), thermoplastic vulcanate (TPV), thermoplastic elastomer (TPE)) is injected onto the frame and glass to form gasket 40, as shown in FIG. 16H. After the components have sufficiently cooled, the tool is opened and the finished piece is extracted, as shown in FIG. 16I.

One challenge with the first approach described above is that the frame tool generally needs to clamp onto the glass to prevent flashing over the optical surfaces. This may be addressed by floating the aperture insert on a spring to allow some compliance. Typically, the clamping pressure should be greater than the pressure required in the second approach due to the injection pressures necessarily being higher than with the elastic gasket component. Additionally, the area available to the rubber component to bond to the glass is significantly lower in the first appraoch as compared to the next second approach. The one advantage of over-molding at this stage is that the thermoplastics used to mold the frame are less likely to sustain a flash, and more likely to freeze fairly close to where the flashing initiated.

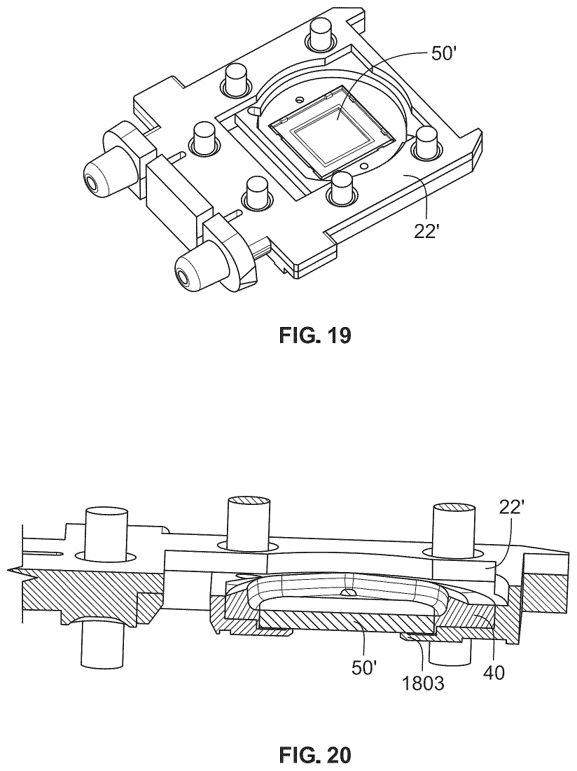

FIG. 17 shows the finished piece having a frame 22′ with overmolded gasket 40 and glass window 50′ molded within, thereby forming the flowcell cavity against which the diagnostic chip can be placed and secured by affixing the PCB (not shown). In this embodiment, the frame is generally square shaped and includes a fluidic interface at one end. It is appreciated that these figures are exemplary and that these fabrication methods can be used to form variations on the frame, including that in FIG. 6 in which the frame is enlongated and includes extended input and output channels so that the distal portion having the diagnostic chip is spaced distally to accommodate larger sized instrument interfaces. Additional details of the frame and glass insert can be understood from the views in FIGS. 18-19.

As can be seen in FIG. 18, the frame 22′ includes a pocket 1801 for receiving the glass insert, the pocket having sacrificial retention tabs 1802 in the pocket for the glass window insert. Additionally, there is a recurved lip 1803 at the aperture edge. This lip forms a seal against the glass during the molding of the rubber gasket component, which addresses the principle issue of overmolding a glass insert without breaking the glass between to tooling due to steel to steel compression of the glass, or flashing rubber over the optical surface of the glass due to insufficient clamping of the glass. Alternative solutions include spring loading an insert in the tool that forms the aperture, which allows some compliance of the tool to adequately clamp the glass without breaking it, yet still prevents rubber from shooting across the glass surface. Another approach is to make the tip of the aperture tooling out of urethane, which like the spring insert, allows some compliance of the tool while preventing rubber from flashing over the optical surface of the glass.

An additional benefit of the recurved lip and the sacrificial location bosses is that these features allow the rubber to flow around the edges of the glass and onto the backside of the glass and the bottom of the glass pocket in the frame. FIG. 20 shows a cross section of how the thermoplastic rubber, upon being injected, wraps around edges and back of the glass window, and shows the detail of the return lip around the aperture of the frame. This provides a relatively large bonded interface between the glass and the gasket material which prevents leaks, as well as reduces internal reflection (e.g. key to chip performance) due to an air/glass interface. In some embodiments, not only does the rubber serve the function of sealing the flow cell, it can also be filled with carbon black to sequester stray light, in the form of internally reflected light, or off axis light.

In another aspect, the chip carrier device in FIGS. 18-20 further includes two slits 1804 adjacent to the fluidic ports. These slits allow the ports to have some movement relative to each other which improves the sealing function to the cartridge by allowing some compliance to account for molding tolerances of both the cartridge and the reaction tube frame. It is appreciated that these slits could be included along the frame and fluidic interface of any of the chip carrier devices described herein.

### III. Alternative Features

Embodiments previously described in U.S. Provisional Application No. 62/734,079 assume use of a chip design fabricated according to conventional techniques. The current low cost state of the art is to use chip on board (COB) strategies to eliminate separate semiconductor packaging elements. Generally, COB techniques rely on a PCB substrate to which the chip is mounted and perform wire bonding operations and subsequent bond protection operations on the device. The PCB serves the purpose of creating a mounting surface for the chip and utilizes vias on the PCB to electrically connect the chip to connection points (e.g. probe contact pads) disposed on the side opposite the chip. This approach allows a large number of contact pads to be distributed over the relatively large surface area on the opposite side of the chip. Use of a separate PCB in this manner aids the semiconductor processing workflow and is the widely accepted, most common approach. One significant drawback with this approach is that it is fairly expensive, requiring additional materials within the PCB (often costing as much as the chip itself) and incurs further expenses within the workflow steps needed to clean and mount the chip on the PCB. Therefore, the disclosure described herein provides alternative, integrated approaches to designing and fabricating a diagnostic chip to facilitate use within a chip carrier device and take advantage of existing sample preparation techniques while further reducing the fabrication and workflow costs of the chip. These approaches are advantageous over conventional COB techniques and allow for the further simplification without any modification or only slight modification in chip design.

There are several different approaches proposed for streamlining diagnostic chip design for use with the sample processing systems and methods described herein. These approaches include: (i) utilizing probe contacts on a separate PCB adjacent the chip, which allows for additional alternative approaches including: (ii) given the reduced size/thickness requirements of any PCB or support substrate of the diagnostic chip, replacing the PCB with a less expensive support substrate (e.g. thinner, lighter, more flexible, etc.) (iii) utilizing flex PCB and tab bonding techniques; (iv) using a metal core board to support the chip as a thermally conductive mount; (v) eliminating the substrate entirely and forming probe contact pads in the chip itself.

### A. Probe Contacts on Separate PCB

In a first aspect, the streamlined chip design entails substantially reducing the size of the PCB and moving the PCB alongside of the chip device (e.g. semiconductor/MEMs) and performing the wire bonding/wire bonding protection in the areas of co-adjacency of the components. In this approach, the diagnostic chip is designed to electrically connect with probe contacts provided on a separate PCB board. This allows the PCB board or substrate of the chip to be reduced in size and further allows the probe contacts to be probed from the same side as the chip. In some embodiments, this approach mounts both the PCB and device onto a separate surface, typically during the same pick and place operation of the semiconductor packaging work flow. This allows the mounting substrate to be very inexpensive, such as plastics and composites, and also opens the possibility of using thermally conductive metals or ceramics as the supporting substrate. This strategy generally prefers that the connections to the completed device be made from the same side as the devices. In some embodiments, this concept could be used and configured such that the probe contacts still face in the opposite direction. The main cost reduction is the size of the PCBs and the flexibility given to the process by allowing different PCBs and chip devices to be matched without significant redesigns.

### B. Alternative Chip Substrates/Connection Types

In some embodiments, the chip carrier device can be configured so that the probe contacts are provided on the PCB. In this approach, by providing the probe contact pads are provided on a separate PCB, the support substrate of the chip can not only be smaller and thinner, but can utilize various different materials that are less expensive and/or have additional mechanical properties that provide further advantages. For example, the substrate can be a flexible material, such as a flex laminate, which are more economical. Further, the reduced area allows the substrate to be more easily mounted, for example, a self-adhesive flex laminate feature can be used as the adhesive provides sufficient bond strength for a smaller lighter flex laminate (as compare to a conventional PCB component). In another aspect, the PCB on which probe contacts are provided can also be flex PCB. This lends itself to less expensive bonding methods such as TAB bonding techniques, which are generally cheaper and faster than wire bonding at very high volume production.

### C. On-Chip Probe Electrical Contacts/Connections

In one aspect, the diagnostic chip can be designed to use probe contact pads defined in the chip itself. This approach utilizes an additional portion of the chip (on a same side as the active area) such that wire bonded connections through a PCB are avoided. This design avoids the necessity of a separate PCB component for the probe contacts and further avoids any bonding procedures and various workflow steps. In some embodiments, the chip can be manufactured on an alternative support substrate, such as any of those described herein. Advantageously, the chip can be manufactured without any separate support substrate, for example, the silicon wafer in which the chip is defined can act as the support. In such embodiments, a step of thinning the silicon wafer is unnecessary, thereby providing a more cost effective and streamlined fabrication as compared to conventionally packaged chip devices. In such embodiments, any available wafers can be used, for example wafers having a thickness of 925, 775, 725, 675, 625, or 525 μm (thicknesses typically corresponding to wafer diameter). It is appreciated however that any suitable thickness wafer could be used.

This approach allows for an even more cost effective approach of eliminating the separate PCB entirely and thus any electrical bonding requirements to the chip. By putting the onus of making the electrical connections to the chip onto the instrument entirely, the need for a separate PCB, PCB Flex component, and wire or TAB bonds and protection can be completely eliminated. This allows for a design where the chip (e.g. bare silicon/MEMS device) can be mounted directly into an integral flowcell/chip carrier device. The elimination of the steps pertaining to the separate PCB and associated electrical connections save time and cost on the order of the cost of the chip itself. Typically, this approach prefers that the chip (e.g. silicon/MEMS device) has a reasonably low number of connections such that a sufficient area on the device can be allotted to the connections. This approach may incur some additional cost in regard to the additional area of silicon utilized for the contact connections, but for most chip designs, this increase in cost is significantly offset by the savings in the elimination of the separate PCB and associated reduction in workflow.

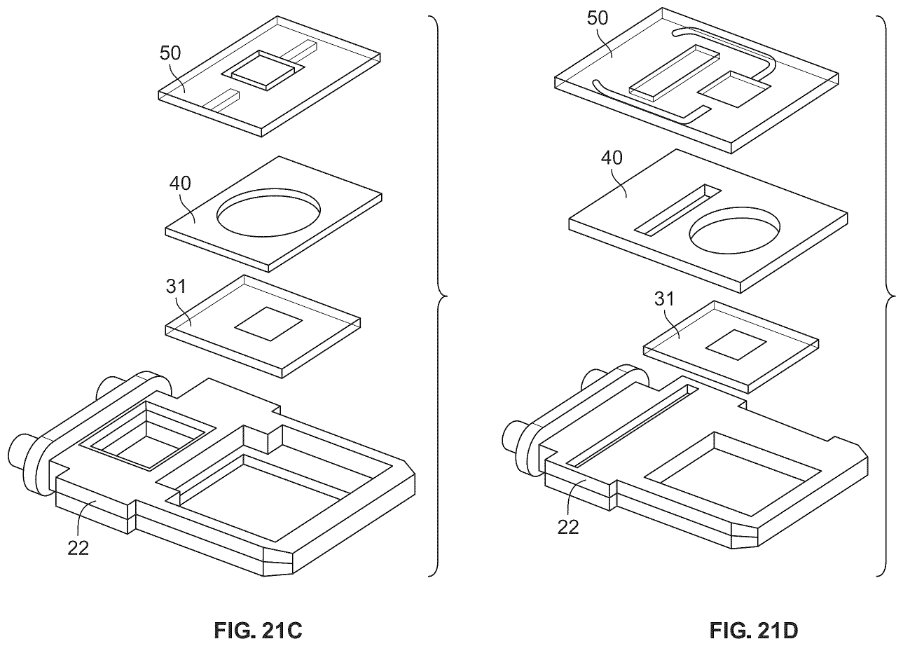

FIGS. 21A-21D illustrate alternative concepts for chip carrier devices, in accordance with some embodiments. FIG. 21A shows a single shot tube design of the chip carrier frame 21 wherein the optical lid and the frame are formed as a single component, for example, by injection molding. In this embodiment, the chip 31 is mounted with a gasket 40 by swaging (hot or cold) or bonded with adhesive. FIG. 21B shows a chip carrier device with a frame 22 having longer channels inbuilt, a drop-in chip 31, two gaskets 40, 40′ and a glass optical lid 50′. The two gaskets can be bonded together to form channels. FIG. 21C shows another chip carrier device having a frame 22, a drop-in chip 31, a drop-in gasket 40, and a molded optical lid 50. The optical lid can be molded to include features, such as channels. The single layer gasket has a relatively small surface area. FIG. 21D shows another chip carrier device having a smaller frame 22 with channels inbuilt (by pins), a drop-in chip 31, a larger gasket 40 with added access window opening, and a molded optical lid 50 that include one or more channels. In some embodiments, the optical lid can be replaced with a thin film that is laminated or laser welded to the frame. In any of the embodiments herein, the gasket can be formed of one or more very high bonding (VHB) layers, silicone, or any suitable material. In any of the embodiments, the chip can be secured to the frame with the gasket in between swaging (hot or cold), heat staking, adhesive or any suitable means.

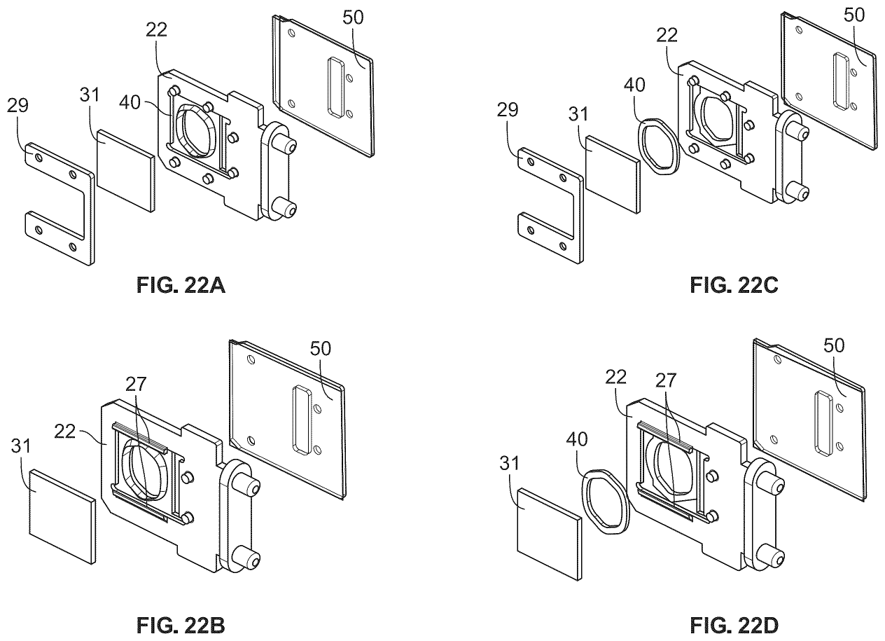

FIGS. 22A-22D illustrate alternative concepts for chip carrier devices, in accordance with some embodiments. FIG. 22A shows the overmolded gasket approach described previously, the gasket 40 being formed by overmolding within the frame 22. In this embodiment, the chip 31 (also referred to as “die”) is placed in a recessed region over the overmolded gasket 40 and can be attached by heat staking using a metal bracket 29 that is heat staked to the frame 22 to securely engage the gasket and form a fluid-tight seal around the flow chamber. The optical lid 50 is attached to the opposite side by any suitable means. FIG. 22B shows another approach utilizing an overmolded gasket in which the chip 31 is attached by swaging (hot or cold) swaging bars 27 (i.e. protrusions, ridges, lips) on opposite sides of the flow cell. The optical lid 50 is attached to the opposite side by laser welding or any suitable means. FIGS. 22C and 22D show a drop-in gasket approach, in which a separately formed gasket 40 is dropped into the recess to define a seal around the flowcell, then the chip 31 is placed in the recess over the gasket and secured. The gasket can be a silicone gasket. The chip can be secured by heat staking, using a metal bracket 29 that is heat staked onto the frame 22, as shown in FIG. 22C, or can be coupling by swaging bars 27 that are swaged (by hot or cold swaging) over the backside of the chip 31.

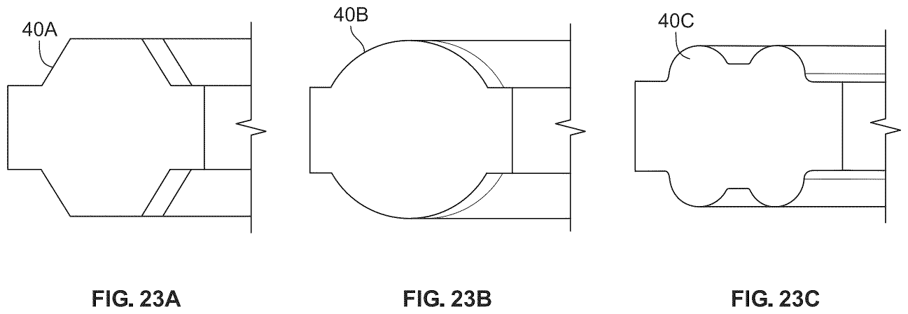

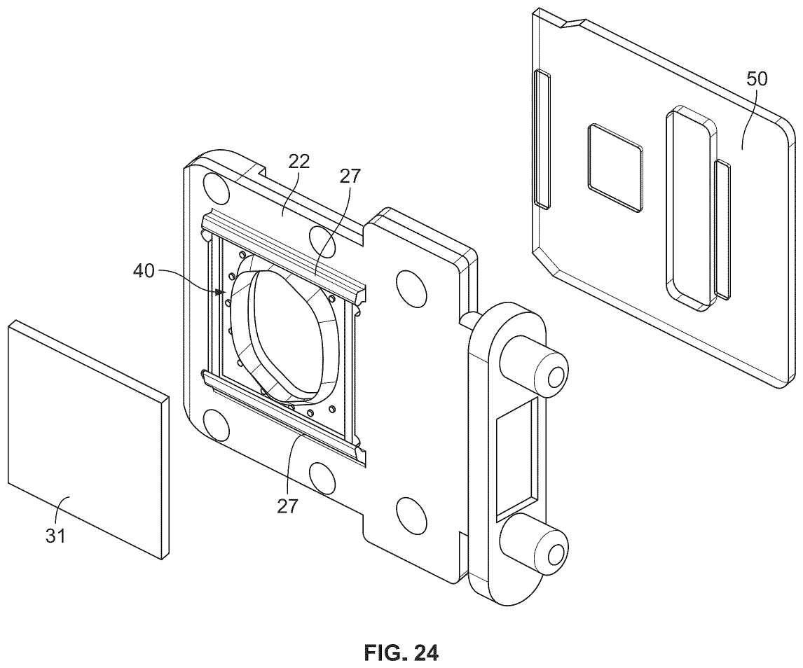

FIGS. 23A-23C illustrate differing types of gaskets in accordance with some embodiments. Three different designs were tested for the gasket, a buttress shape 40A (shown in FIG. 23A), a circular shape 40B (shown in FIG. 23B) and a double bead shape 40C (shown in FIG. 23C). The circular design was advantageous as it was found to be less susceptible to performance degradation due to lot-to-lot material variation, however it is appreciated that various shapes could be used depending on device and requirements. Differing hardness of materials were also studies, including 40a and 50a on a Shore hardness scale. In most applications, 50 A was preferred. Due to difficulty in assembly, the yield of 40 A gaskets was found to be significantly lower compared to 50 A material. However, one advantage of the 40 A material is reduced susceptibility to electrical connection failures, because the material is softer. Generally, chip height data does not show a correlation to the performance of different gasket designs. The buttress design demonstrated less variation in maximum height between parts than other designs. In some embodiments, the gasket is silicone of a circular cross-sectional design and a 50 A hardness.

FIG. 24 illustrates a chip carrier device design utilizing swaging of the die over the gasket, in accordance with some embodiments. As described previously, the gasket 40 is formed by overmolding within the frame 22, which includes a chip receiving region in which the chip 31 is secured so that the active face is disposed in the flowcell that is defined by the frame, gasket, and optical lid 50. In this embodiment, the chip 31 gets swaged into the overmolded frame 22, thereby compressing the gasket 40, which in turn provides a fluidic seal of the reaction volume. This design includes swage bars 27 on opposite sides of the chip recess that get swaged over the rear side of the chip to secure the chip to the frame and compress the gasket material in between. Swaging can be cold swaging or hot swaging. In some embodiments, the optical lid 50 is laser welded onto the frame, thereby providing fluidic seal of channels and reaction volume within the flowcell chamber. In some embodiments, the frame material is COP. In some embodiments, the lid material is COP. In some embodiments, the gasket material is TPE (for overmolded gaskets). It is appreciated that various other materials could also be used for each.

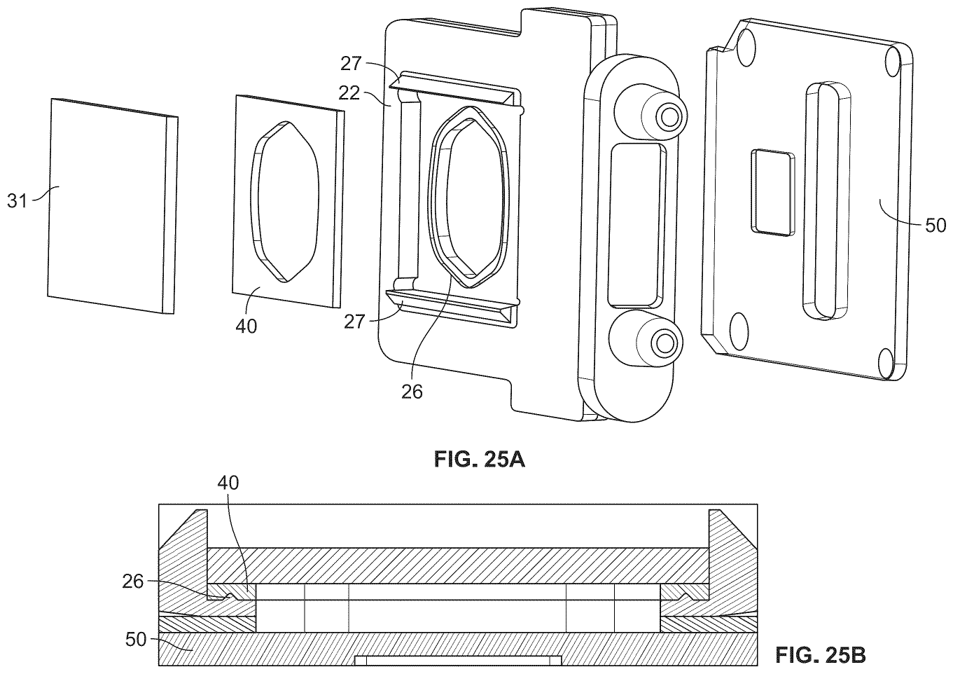

FIGS. 25A-25B illustrate chip carrier device design utilizing a drop-in gasket and swaging, in accordance with some embodiments. In this embodiment, the gasket 40 is separately formed and dropped into the recess of the frame 22 before the chip is placed in the recess and secured to the frame. In this embodiment, the chip is secured to the frame by swage bars 27 on opposite sides of the recess, thereby compressing the gasket 40 between the chip and the frame forming a fluid-tight seal about the flowcell chamber. The gasket can be one or more layers of silicone, an elastomer, or any suitable material. In this embodiment, the frame 22 further includes an energy director ridge 26 disposed about the flowcell chamber to provide gasket compression where needed most, as shown in the cross-sectional view of FIG. 25B. As shown, the ridge is a single raised ridge, but it is appreciated that various other designs (double ridge, triple ridge) could be realized.

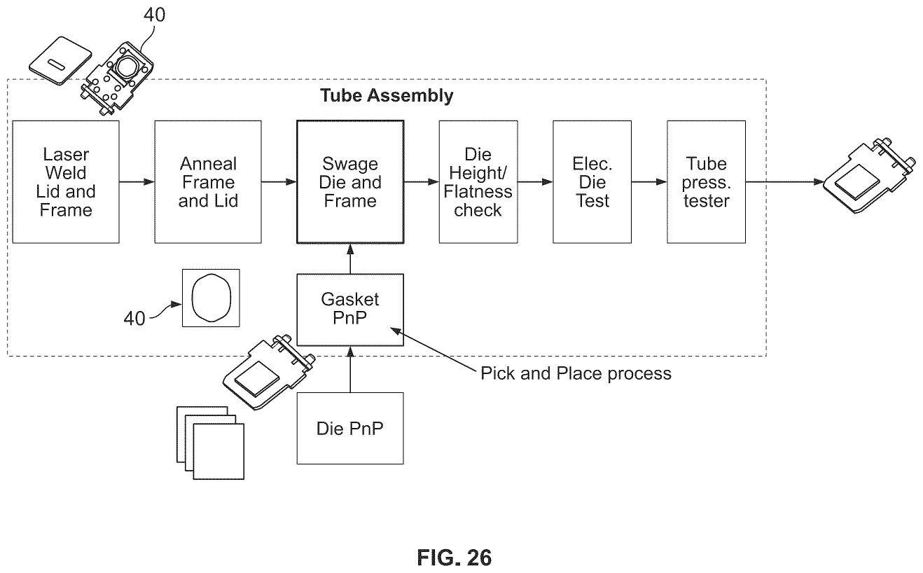

FIG. 26 illustrates a flowchart for manufacturing a chip carrier device utilizing a drop-in gasket, in accordance with some embodiments. As can be seen, much of the process can utilize existing manufacturing equipment and workflow procedures currently used in manufacturing of reaction vessels. It is appreciated that this process flow represents one approach of assembling the drop-in gasket chip carrier device and that various other steps or modifications could be used.

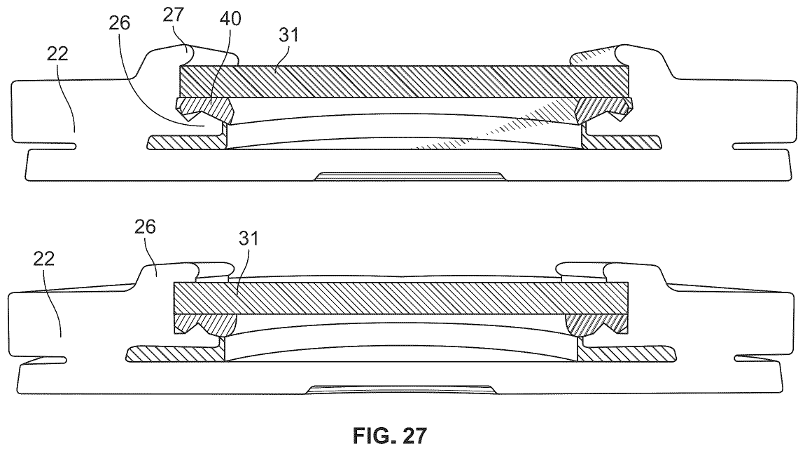

FIG. 27 shows study results demonstrating gasket integrity in response to swaging, in accordance with some embodiments. As can be seen, the frame 22 includes an energy director ridge around the flowcell, as previously described. Upon swaging of swage bars 27 over the rear facing edges and corners of the chip 31, the gasket 40 is compressed. Each image shows a 0.5 mm thick gasket of 35 A hardness silicone that is compressed by the chip having been secured to the frame by a swaging process. At top, the chip was secured by a cold swage process, which shows a relatively small amount of overlap of the swage bars 27 along the edges of the chip 31. At bottom, a hot swaging process is shown that has improved the flow of material and increased the level of overlap over the edges of the die. For this reason, hot swaging appears advantageous in providing a more secure coupling of the chip to the frame. Each appears to show suitable compression of the gasket to form the seal about the flowcell.

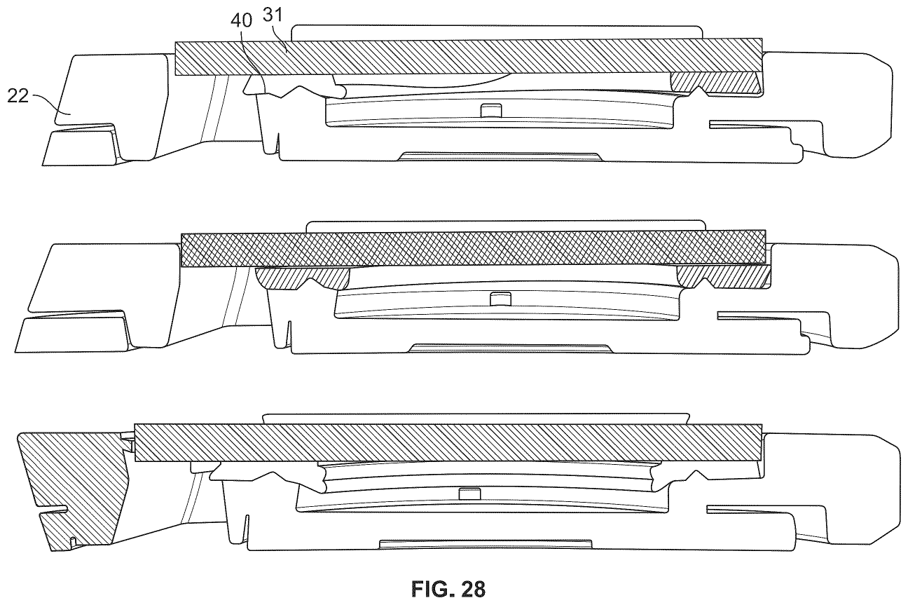

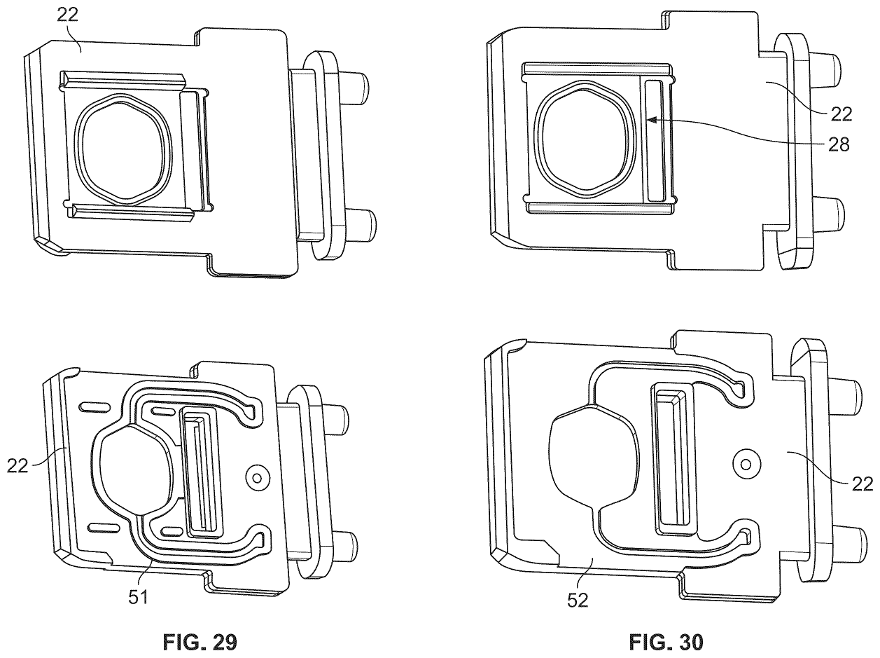

FIG. 28 illustrates study results examining the integrity of different gasket materials, in accordance with some embodiments. At top, a silicone gasket of 0.4 mm thickness and 50 A hardness shows uneven compression, however part of this is likely attributed to the use of cold swaging. It is believed that hot swaging may further improve uniformity of compression for some gasket designs. At middle, a silicone gasket of 0.53 mm thickness and 35 A hardness showed even compression all around the gasket. At bottom, a silicone gasket of 0.45 mm thickness and 20 A hardness showed over compression and excessive material displacement both inside the flowcell chamber and into the adjacent access window region.

FIG. 29 illustrates another chip carrier device having a welding surface for attaching the optical lid, in accordance with some embodiments. At top is shown a front side of the frame 22 having the chip recess area. At bottom is shown a rear side of the frame 22 that shows the channels leading to the flowcell, which are both sealed by attaching the optical lid. In this embodiment, the frame 22 includes a flattened edge 51 that extends around the flowcell and channels to facilitate laser welding along this edge to ensure a fluid-tight seal between the optical lid and the frame 22. The embodiment depicted in FIG. 29 can be for a 0.4 mm gasket with a die height of 0.2 mm.

FIG. 30 illustrates another chip carrier device having a welding plateau for attaching the optical lid and a rib for limiting gasket movement, in accordance with some embodiments. At top is shown a front side of the frame 22 having the chip recess area with swage bars 27 on opposite sides of the chip recess. An additional rib 28 has been added between the chip recess and the access window to access the electrical contacts with the electrical interface. Rib 28 prevents excess gasket material from extending out into the access window. At bottom is shown a rear side of the frame 22 that shows the channels leading to the flowcell, which are both sealed by the optical lid when attached. In this embodiment, the frame 22 includes a flattened raised plateau 52 that extends around the flowcell and channels to facilitate laser welding along this edge to ensure a fluid-tight seal between the optical lid and the frame 22. The raised plateau allows additional options as to the laser weld, for example, a wider weld line, multiple weld lines, or increased surface contact for other bonding methods, such as adhesives. The embodiment depicted in FIG. 30 can be for a gasket with a pocket depth of 0.4 mm with a die height of 0.0 mm.

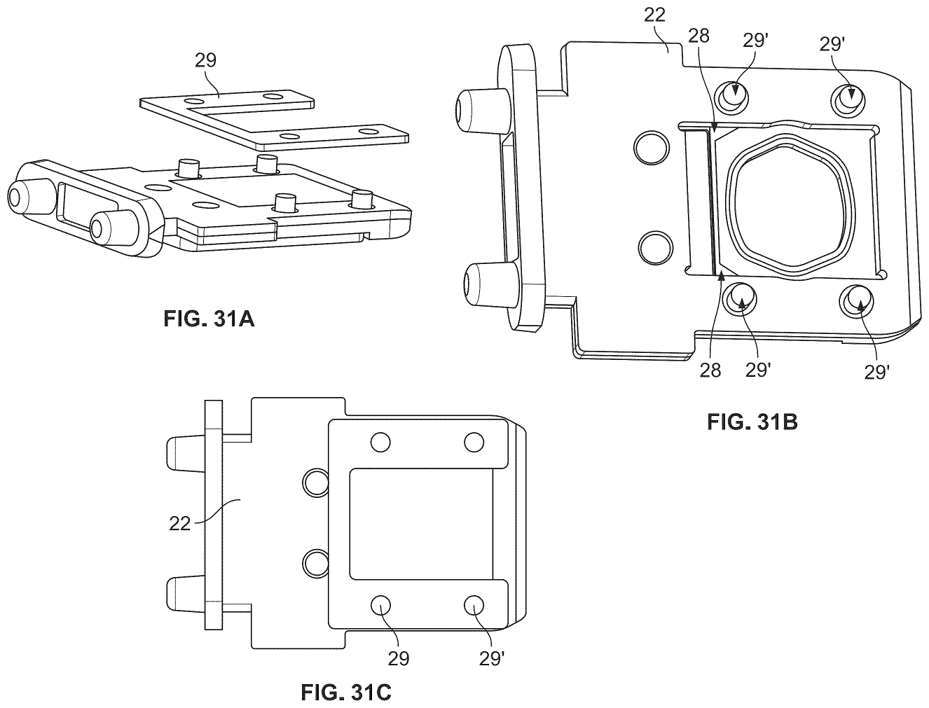

FIGS. 31A-31C illustrate another chip carrier device utilizing a heat stake design and improved rib geometry, in accordance with some embodiments. In this embodiment, a heat stake bracket 29 is heat staked along the frame 22. The frame engages at least some of the outer edges of the chip to secure the chip to the frame and applies enough force to sufficiently compress the gasket to form a fluid-tight seal around the flowcell. Typically, the frame is metal. In this embodiment, the frame is U-shaped such that it extends along at least three of the four edges of the chip. It is appreciated that various other shapes could be used. The frame includes holes that receive heat staking posts 29′ that extend from the planar surface of the frame. The frame is applied so that the staking posts 29′ extend through the corresponding posts and pressure and heat are applied to melt the distal end of the posts, which flow to form a rounded cap that flows over the frame, thereby heat staking the metal frame to the carrier frame. In this embodiment, the frame 22 further includes a rib 28 to prevent flow of excess gasket into the window area.

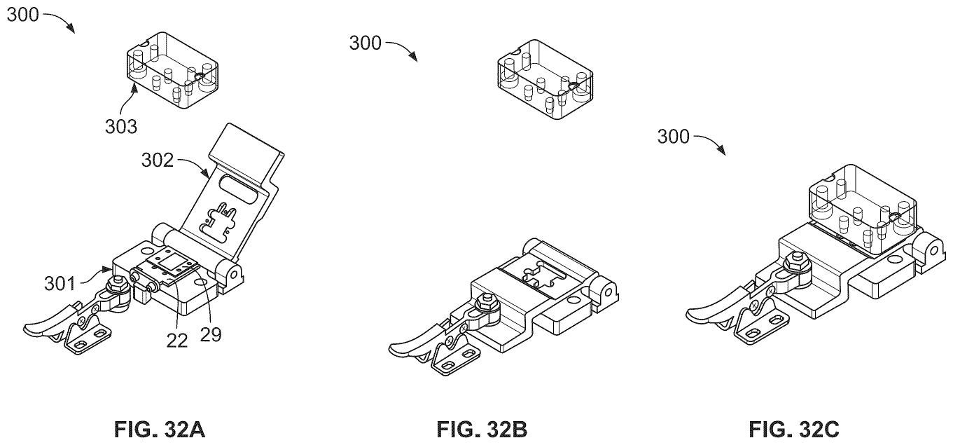

FIGS. 32A-32C illustrate a fixture for heat staking a chip carrier device, in accordance with some embodiments. As shown, the heat staking fixture 300 includes a base 301 with a nesting region configured for holding the chip carrier frame with the heat staking frame placed thereon, as shown in FIG. 32A. An attached clamp 302 pivots over the base to apply pressure to the retainer bracket and frame, as shown in FIG. 32B. A thermal probe 303 is then applied over the clamp, as shown in FIG. 32C and generates sufficient heat to partly melt the heat staking posts and secure the metal frame to the carrier frame 22. In some embodiments, the thermal probe from the existing manufacturing line of the conventional reaction vessel can be used.

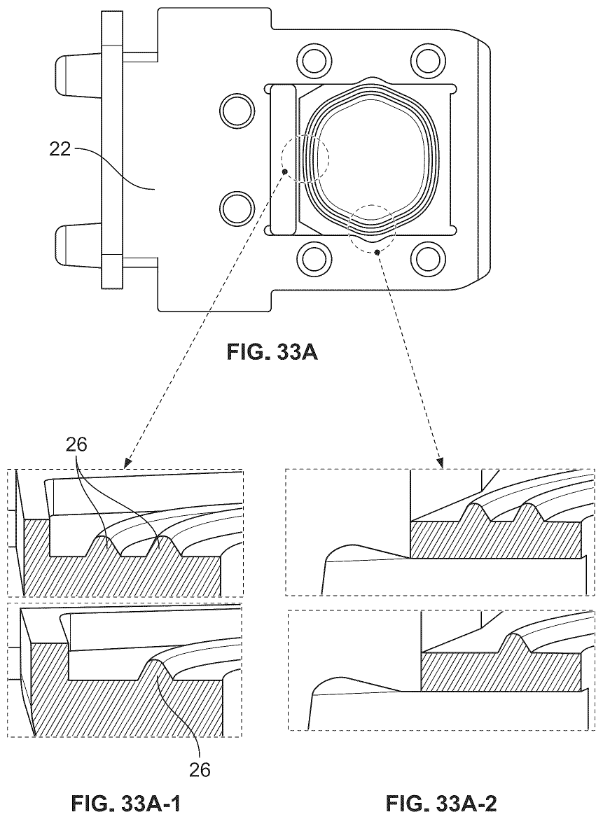

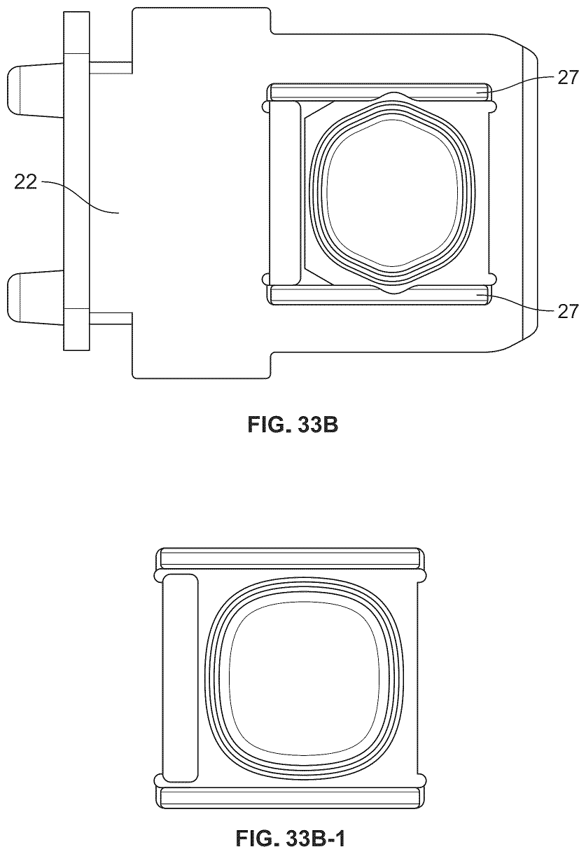

FIGS. 33A-33B-1 illustrate chip carrier devices utilizing single and double energy director features for the gasket, in accordance with some embodiments. FIG. 33A shows a heat staking design of carrier frame, as previously described, and having double-energy director (“ED”) ridges 26 extending around the flowcell chamber, which provides increased compression along the energy directors to improve sealing when the gasket is compressed. FIG. 33B shows a swage design carrier frame 22 having swaging bars 27, which also includes a double-ED ridge 27 around the flowcell. FIGS. 33A-1 and 33A-2 shows first and second examples of double-ED ridge configurations and singled-ED ridge configurations and associated dimensions. It is appreciated that these or various other dimensions could be used and that the double-ED design could be used with either the swaged design or the heat staked design. In some embodiments, the ED-design may require altering the geometry of the chip recess or the flowcell chamber, as shown in FIG. 33B-1, to provide additional clearance for increased width of a double ED design.

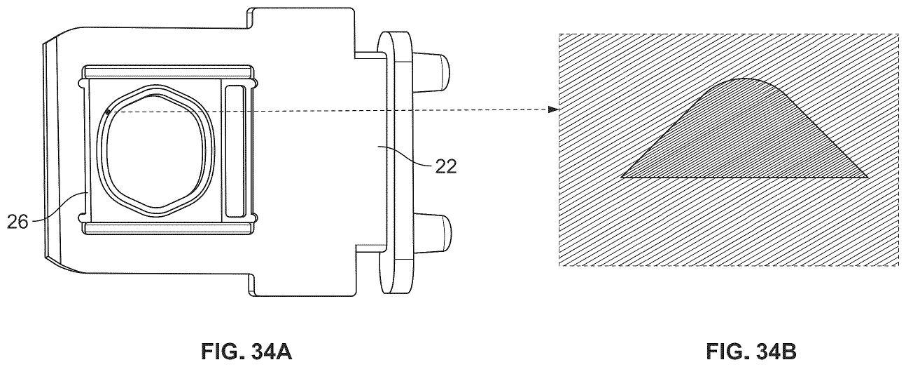

FIGS. 34A-34B illustrate a chip carrier device frame 22 having a modified ED ridge 26 design and added rib geometry along the access window for the electrical interface connector, in accordance with some embodiments. As shown, the carrier frame 22 includes a single ED ridge 26 with a more gradual slope, as shown in FIG. 34B. In this design, the access window includes a modified cut-out designed to provide support for the gasket to resist movement of the gasket into the pogo area during gasket compression and pressurization of the chamber.

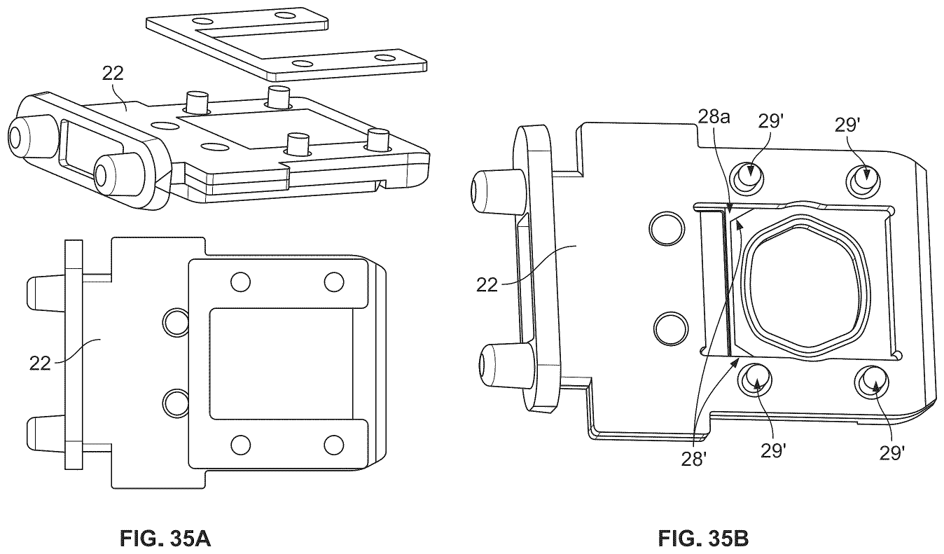

FIGS. 35A-35B illustrate a chip carrier device utilizing heat staking and having specialized rib 28′ along the access window for the electrical interface connector with non-symmetrical features in the chip recess to facilitate assembly of the drop-in gasket, in accordance with some embodiments. As shown, the carrier frame 22 includes heat staking posts 29′ and further includes specialized rib 28′ to prevent flow of excess gasket into the access window area. In this embodiment, the rib further is modified to include corner regions 28a such that the drop-in gasket area is non-symmetrical, which ensures the gasket can only be placed within the recess in one orientation.

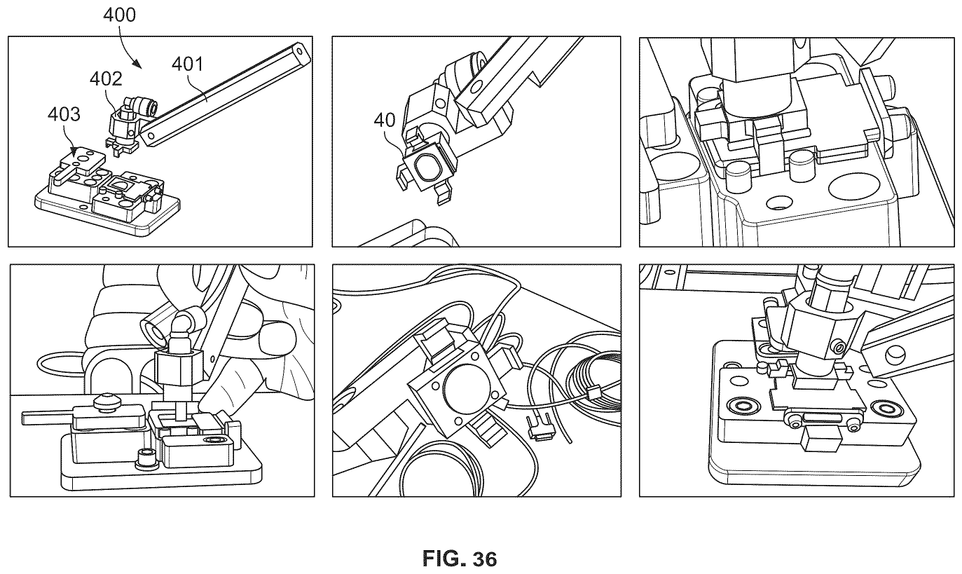

FIG. 36 illustrate a precision gasket placement fixture 400 for assembling the drop-in gasket in a frame of a chip carrier device, in accordance with some embodiments. Due to the relatively small size of the chip carrier frame, precise placement of the gasket within the recess can be difficult. Accordingly, the gasket placement fixture 400 includes an elongate tool 401 that extends to a distal grasper 402 that is actuatable to pick up and release the gasket 40 after the grasper is placed in a precise position atop the chip carrier frame held within a nesting region of the base 403. Typically, the arm is manually held and positioned, as shown. It is appreciated that the arm could also be robotically controlled or automated in other embodiments. As shown, the grasper can include one or more alignment features, such as a non-symmetrical protrusions or arms (typically three or more) that align the grasper with the recess in the chip carrier frame held within the base. The grasper can include one or more pneumatic ports that use suction to pick up the gasket for positioning and that release the gasket by compressed air. It is appreciated that various other approaches can be used to pick up the gasket. By this approach, the process of placing the drop-in gasket is still manual, but precision placement is greatly facilitated.

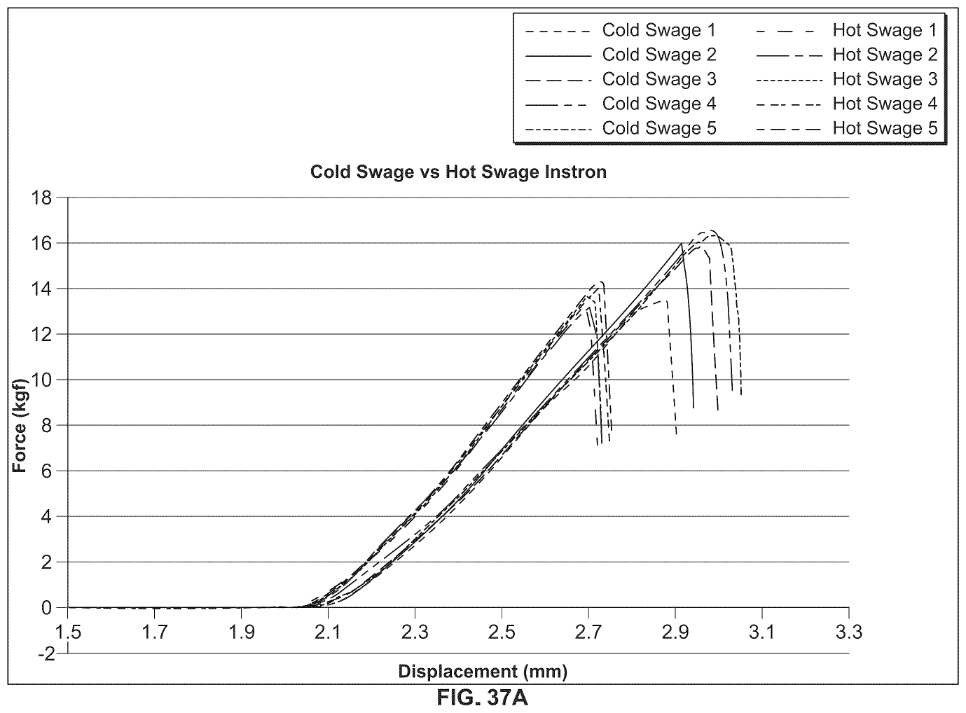

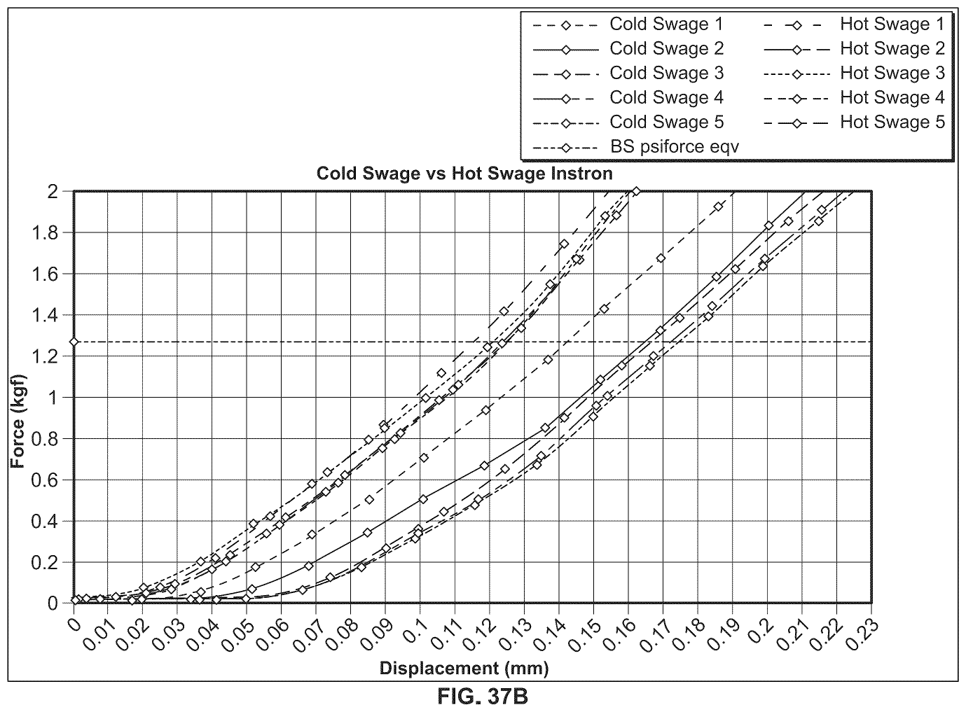

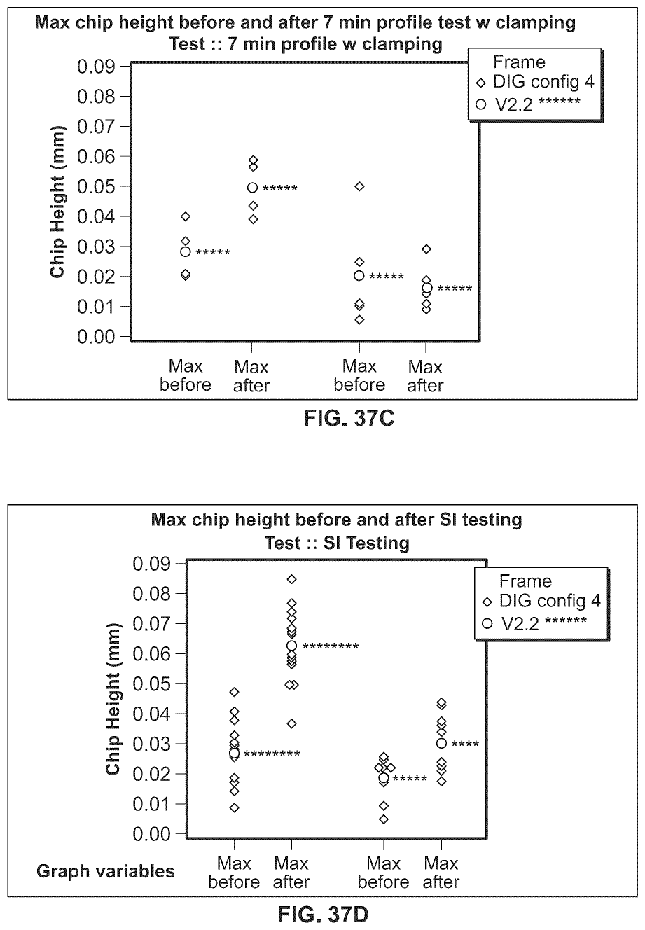

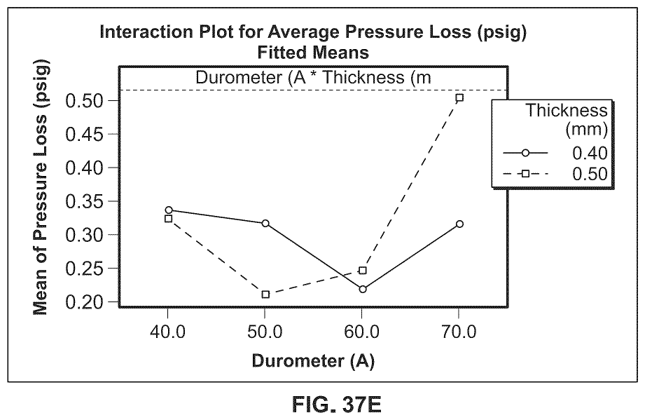

FIGS. 37A-37B show study results demonstrating improved performance by the hot swaging when compared to the cold swaging techniques in attaching the chip to the frame, in accordance with some embodiments. As shown, the results indicate that hot swaging is stronger than cold swaging. Cold swaging refers to a cold working process of applying pressure to deform the swaging bars onto the chip. Hot swaging also refers to a similar process, however, the components are heated during swaging to an elevated temperature within a range of 270-360° F., typically between 320-350° F., which increases the flowability of the material causing more deformation of the material and a stronger connection, although toughness properties of the material in the heated region may be reduced in some instances. It is appreciated that some heat swaging processes may utilize other temperature ranges with higher or lower temperatures. In other embodiments, ultrasonic energy is applied during swaging to reduce swaging force and “cool off” the plastic more quickly to achieve higher initial strength after tool release.

FIGS. 37C-37D show the maximum chip height before and after clamping for the chip carrier devices with overmolded gaskets (also known as “Kraiburg” configuration) and for chip carrier devices with a drop-in gasket (DIG configuration). These results indicated that the chip tends to move more with the drop-in gasket design, at least with the swaging approach.

FIG. 37E show study results evaluating varying durometers and gasket thicknesses. When evaluated within the described chip carrier frames for pressure loss, the study results demonstrated that silicone gaskets of higher durometer material (e.g. 40-60 A, preferably, 50 A and 60 A) performed better and that thickness of 0.4 mm and 0.5 performed optimally as compared to thicker and thinner gaskets. It is appreciated that other embodiments utilizing carriers of differing dimensions and/or differing operating pressures might utilize other thicknesses and hardness. Preferably, the gasket material is silicone, however, it is appreciated that various other materials could be used (e.g. Buna-N, Neoprene, etc.). In the embodiment shown in FIG. 37E, each group consists of N=10 samples and all of the samples were compression molded silicon material from a single supplier.

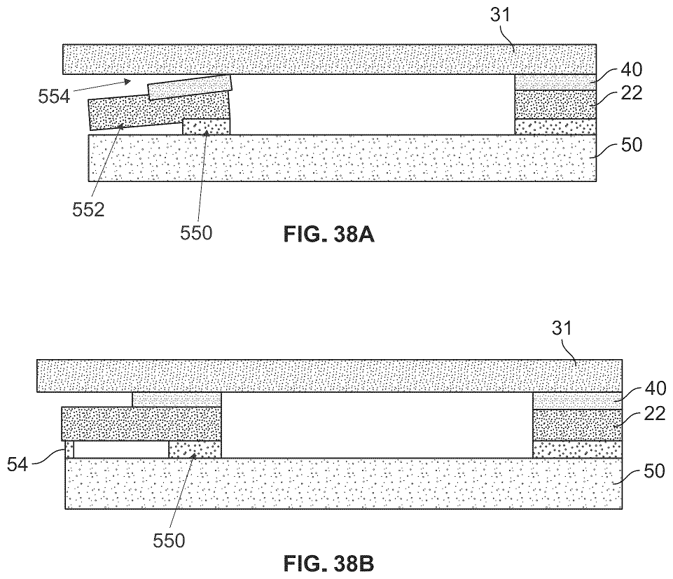

FIGS. 38A-38B illustrate further improvements pertaining to a molded optical lid for the chip carrier device, in accordance with some embodiments. It was noted that, in some cases, welding of the optical lid to the chip carrier can cause warpage of the chip carrier frame, which can compromise the gasket seal and result in leakage, as shown in FIG. 38A. As depicted in the embodiment shown in FIG. 38A, there is weld between the lid and the frame 550 and there can be warpage on the frame 552 which can lead to a leak path 554. As shown in FIG. 38B, a raised ridge 54 can be included along an outer edge of the optical lid 50 to improve uniformity and consistency of pressure from the optical lid 50 stacked on the frame 22, thereby avoiding uneven pressures that may result in warping. The ridge 54 can be an integrally formed ridge formed in a molded optical lid, or can be an added feature by weld or adhesive.

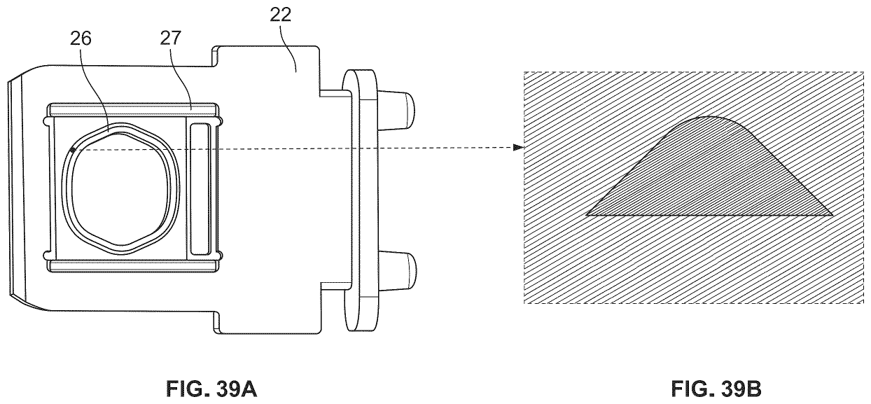

FIGS. 39A-39B illustrate another chip carrier device having added rib geometry along the access window for the electrical interface connector, in accordance with some embodiments. In this embodiment, frame 22 includes an ED ridge 26 circumscribing the flowcell, swage beams 27 on opposite sides of the chip recess, and a cut out design modification the window access to the electrical interface of the chip, as shown in FIG. 39A. In this embodiment, the ED ridge has a gradual slope to a rounded apex and has a height of about 0.2 mm, as shown in FIG. 39B.

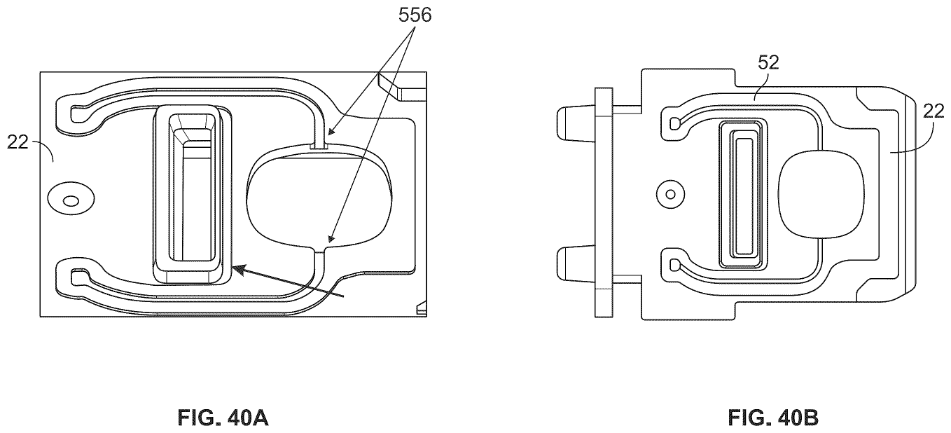

FIGS. 40A-40B illustrate another chip carrier device having an improved welding path for the optical lid, in accordance with some embodiments. In this embodiment, fillets 556 are added at the sharp corners, which can reduce hotspots during laser welding and provide a more gradual fluid flow transition into the reaction chamber. The weld path is separate from the boss around the access window and weld cutout holes have been removed, as shown in FIG. 40A. The weld region is a raised flattened plateau region, shown highlighted in FIG. 40B, which increases the area in which the optical led can be welded to the frame. This weld design supports a larger, wider weld or multiple weld lines at various locations.

FIGS. 41A-41C illustrate another chip carrier device having a modified flowcell shape, in accordance with some embodiments. As can be seen in FIG. 41A, the flowcell shape is more rounded, as compared to the previously described shape shown in FIG. 41B, the more rounded shape allows additional clearance for a double ED design, as shown in FIG. 41C.

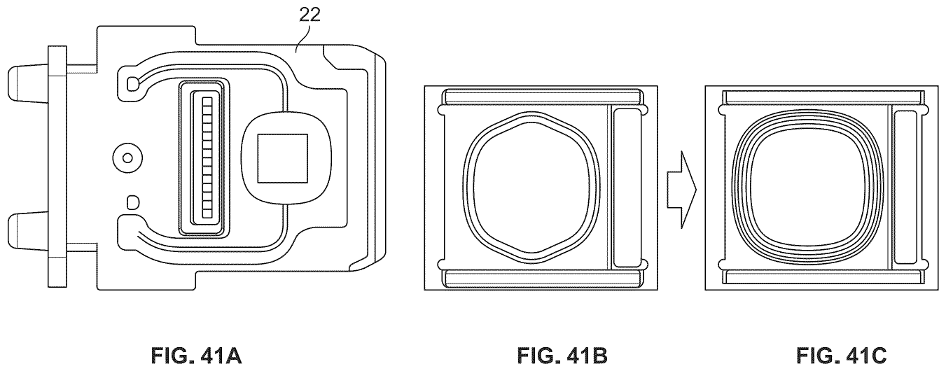

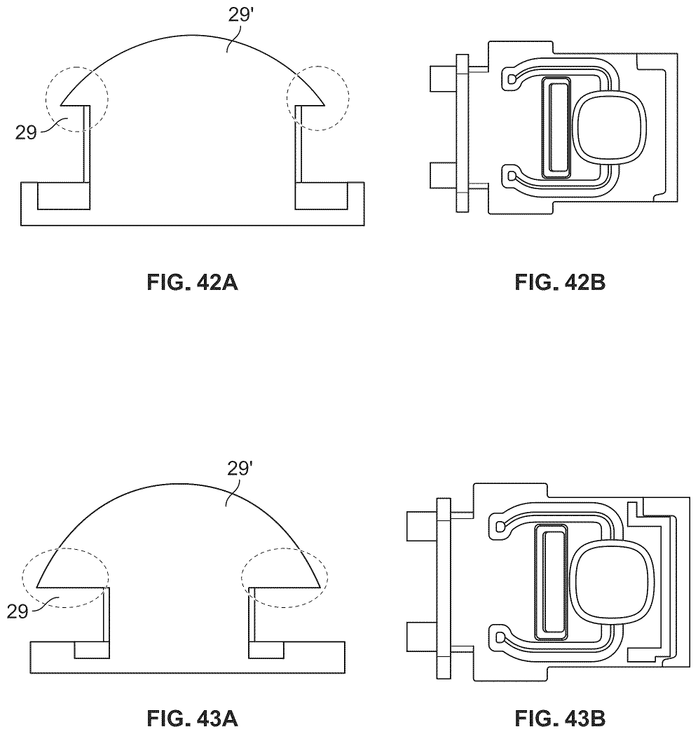

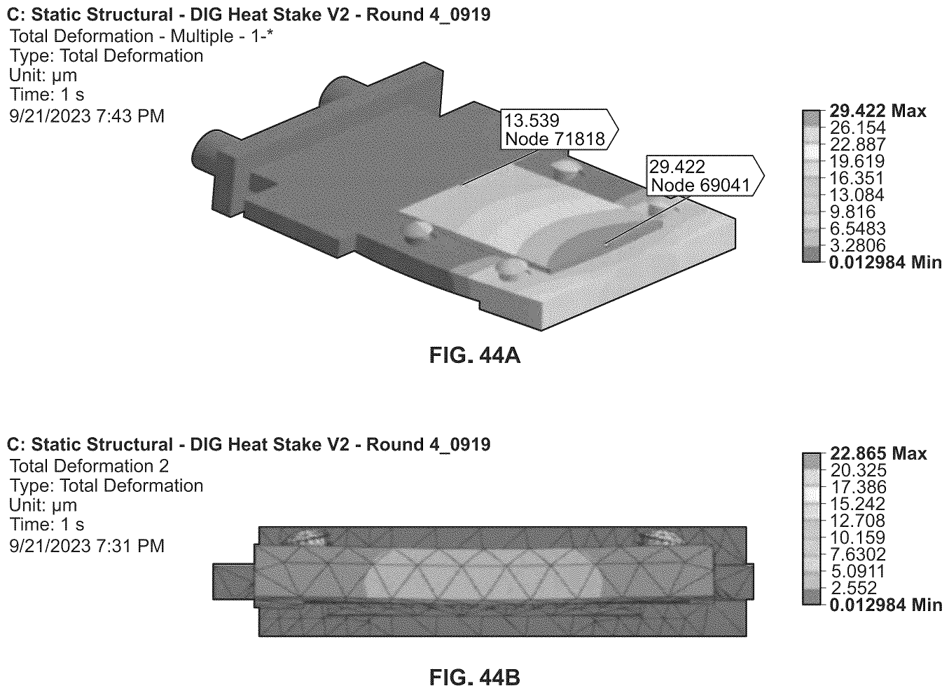

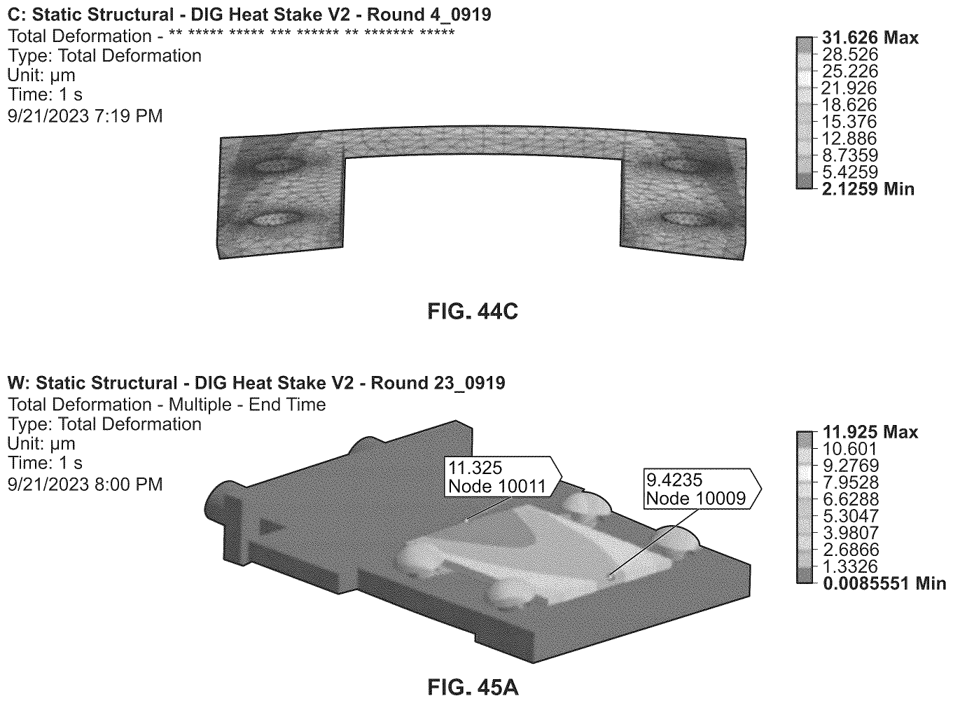

FIGS. 42A-42B illustrate alternative chip carrier device and associated heat staking details, in accordance with some embodiments. In this frame design, the frame has lower stiffness away from the access window, which can lead to detachment of the optical lid and frame at the distal end. This can be addressed by improved attachment of the chip or other features. FIG. 42A show a post of the frame after heat staking on the retainer bracket supporting the chip. FIG. 42B shows a weld region between the optical lid and the frame. FIGS. 44A-44C show a finite element analysis of the deformation of the frame illustrating a chip rise of 29.4 μm at the distal end away from the access window and a chip rise of only 12.5 μm near the access window. This increased chip rise at the distal end can lead to detachment of the optical lid and the frame.

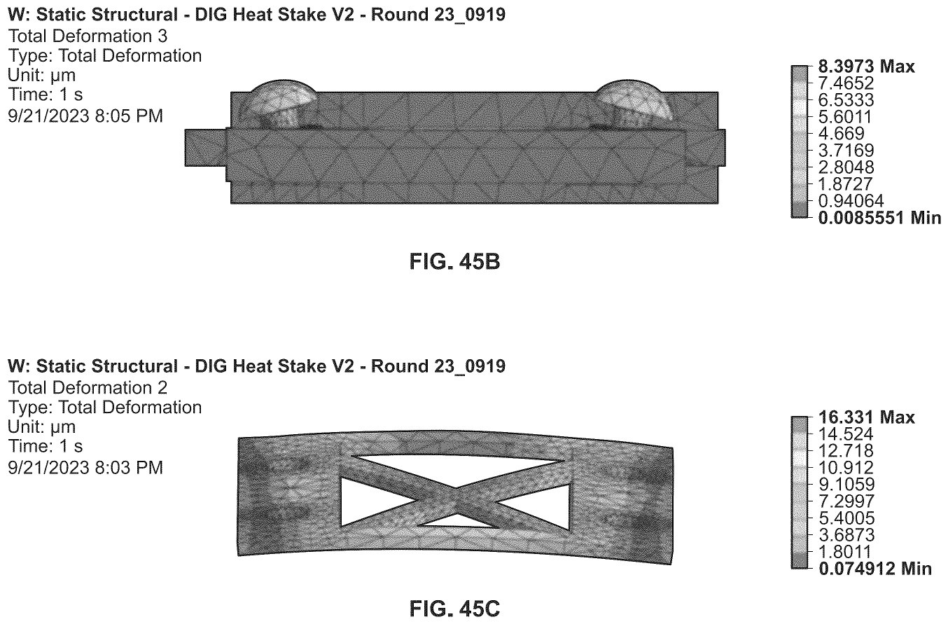

FIGS. 43A-43B illustrate an alternative design of the chip carrier device, in accordance with some embodiments. In some embodiments, an additional weld to increase rigidity at the distal end and improved heat staking can improve the attachment of the chip to the frame. FIG. 43A show a post of the frame after heat staking on the retainer bracket supporting the chip, which has a high dome profile and leads to better surface contact with the retainer bracket (e.g., 0.03″ or 0.75 mm) includes a flow region that extends further than the design in FIG. 42A. FIG. 43B shows the improved device design that includes an additional weld line (see arrow) near the distal end to improve rigidity at the distal end and avoid separation between the optical lid and the frame. FIGS. 45A-45C show a finite element analysis of the deformation of this frame design illustrating a chip rise of 11.9 μm at the distal end away from the access window and a chip rise of only 9.47 μm near the access window.

In another aspect, the device can include a thicker optical lid which further increases rigidity and structural properties. In prior embodiments, an optical lid was typically of a thickness between 0.5 and 1 mm, such as 0.7 mm. In some embodiments, the device includes a thicker optical lid between 1 and 2 mm, such as 1.5 mm. While a thicker lid improves structural rigidity, a thicker lid can present other challenges, such as instrument incompatibility or background autofluorescence. In some embodiments, the device includes an optical lid of a 1.2 mm thickness, which balances structural properties and compatibility.

In another aspect, the device frame can be formed of a low carbon black resin. The combination of carbon black type together with weight percent of carbon black in the polymer will influence the laser absorption of the frame. For a given carbon black type, using lower weight percentages (0.1 percent or 0.15 percent) of carbon black result in partial transmission into the part, yielding sub-surface heating. This is beneficial when thicker melt layers are needed without surface degradation. Alternatively, when using high weight percentages (0.5 percent and higher), most of the absorption is near the surface, which results in thinner melt layers. In some embodiments, the carrier has carbon black content between 0.1-0.15%. Low carbon black content has demonstrated improved laser welds without voids. Low carbon black content in resin typically requires higher energy to weld, but heat is allowed to distribute through the part preventing surface heating and degradation.

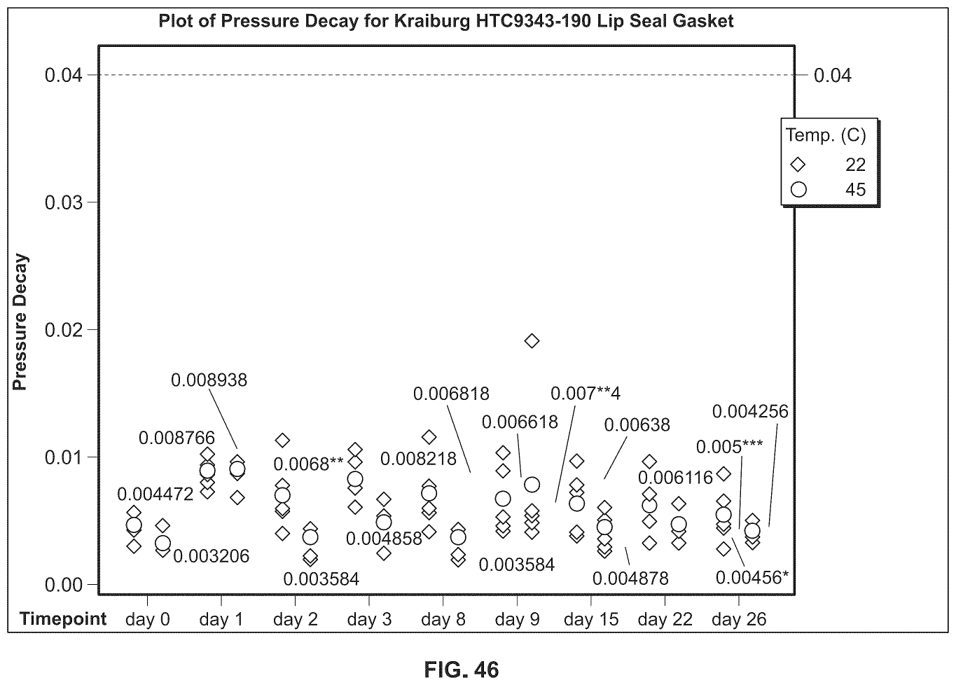

FIG. 46 illustrate study results showing a plot of pressure decay in a chip carrier device utilizing an overmolded lip seal gasket, in accordance with some embodiments. Testing with the overmolded chip carrier device configuration showed passing results over one month at both room temperature and 45° C. This study demonstrates the viability of the overmolded design.

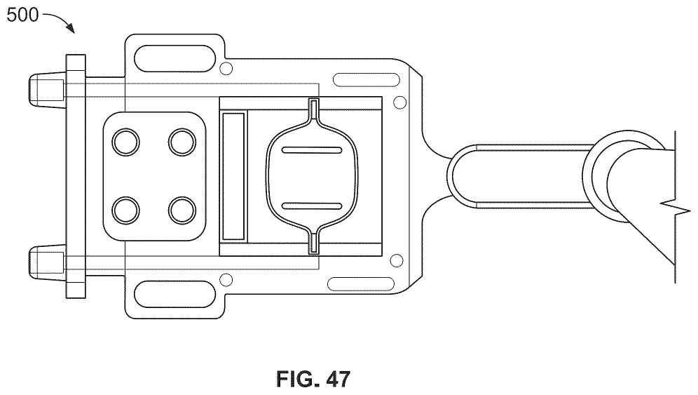

FIG. 47 illustrate a single component, injection molded chip carrier 500 that includes the frame and optical lid as one component. In some embodiments, the device if formed of COP. This design is advantageous in that it combines the carrier frame and the optical lid, thereby reducing costs of manufacture, eliminating laser welding, potentially obviating the annealing step. In this embodiment, the chip can be secured with the gasket by swaging, heat staking, adhesives or any suitable means. This design may present other challenges such as light scatter, such that at least a portion of the device may benefit from a light blocking coating.

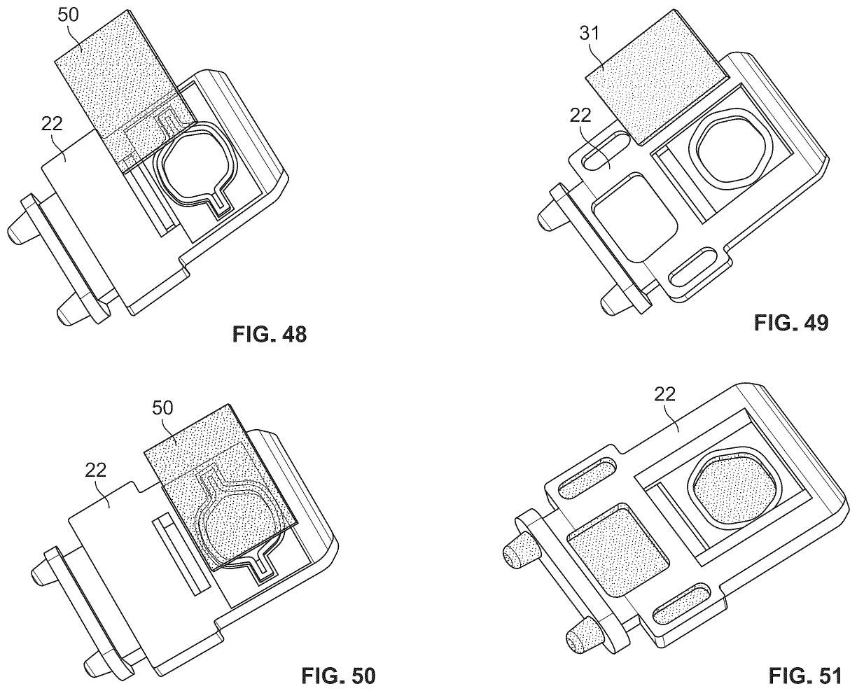

FIGS. 48-51 illustrate examples of differing designs of chip carrier devices utilizing alternative bonding techniques such as adhesives or ultrasonic welds, in accordance with some embodiments. FIGS. 48-49 show opposite sides of a frame. FIG. 48 shows the optical window fitted onto a corresponding recess of the frame and bonded bonding with liquid adhesives, which advantageously allows for other types of materials having improved optical properties, such as a glass window. FIG. 49 shows the chip similarly being bonded by an adhesive (e.g. liquid adhesive). The adhesive can be a curable adhesive (e.g. air, chemical, UV), a pressure-sensitive adhesive, or any suitable adhesive. FIGS. 50-51 show another design that uses ultrasonic welding. FIG. 50 shows one side having ED ridges to facilitate ultrasonic welding of the optical lid to the frame. FIG. 51 shows the opposite side in which the chip is swaged in the recess, as described previously. In either case, a modular tool can be built to facilitate these processes of using adhesive bonding or ultrasonic bonding as described above.

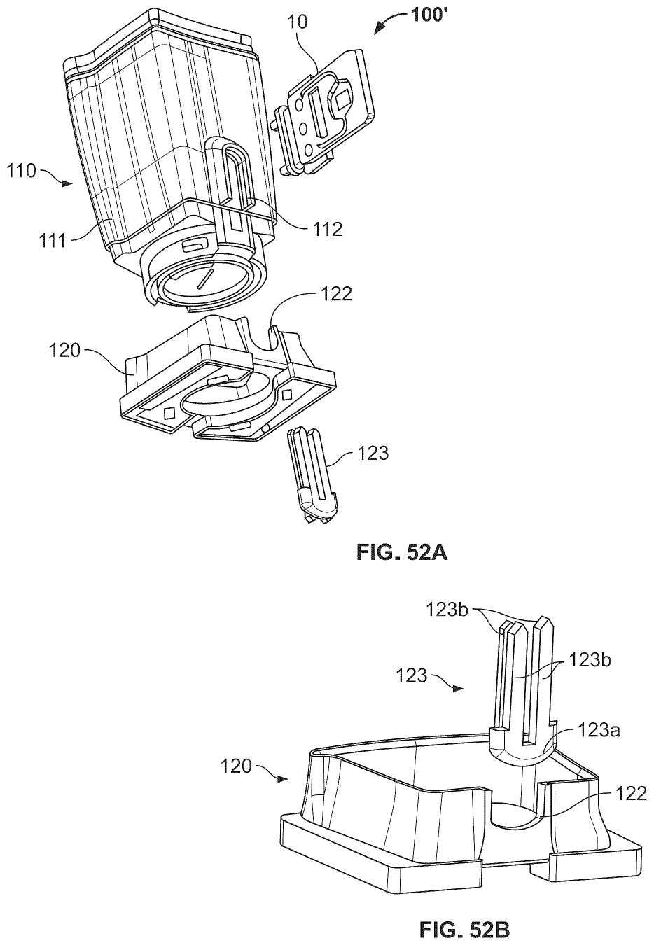

FIGS. 52A-52B shows a cartridge foot and fork bracket to facilitate attachment of a biochip carrier device to the cartridge post-cartridge production. This approach contrasts with conventional cartridges which typically attach a reaction vessel to the cartridge during cartridge production. This is important as it allows the cartridge to be manufactured and inspected for quality prior to inserting the biochip carrier device into the cartridge body. Since the biochip is the most expensive component of the biochip cartridge, it is preferable to avoid discarding a biochip due to a defect in the cartridge identified in inspection. Cartridges undergo many types of testing for pressure leaks, manufacturing defects, etc., which are independent from the biochip and biochip carrier device, and those cartridges that fail testing are scrapped. If the biochip carrier device is secured to the cartridge prior to testing, this would necessitate disposing of the biochip along with the defective cartridge. Accordingly, a mounting configuration that utilizes a separate component, such as a foot fork, allows for mounting of the biochip carrier device to the cartridge after the cartridge has passed testing. While a foot fork is described here, it is appreciated that various other separate components (e.g. clip, pin, etc.), could be used.

FIG. 52A shows an exploded view of the biochip cartridge 100′ having a biochip 10 that is mounted to the cartridge 110 by fork 123. In this embodiment, the cartridge 110 includes a cartridge body 111 and a separate base or foot 120. The fork bracket 123 is designed to interface with corresponding mounting regions 112, 122 in the cartridge body and foot, respectively. The fork bracket engages the proximal flange of the fluidic interface of the biochip carrier device 10. This configuration contrasts with conventional cartridges having attached reaction vessels in that the fork allows personnel to attach the biochip carrier device to the cartridge after cartridge manufacturing and testing, as described above.

FIG. 52B shows a detail view of the cartridge foot 120 and fork bracket 123. As shown, the fork 123 includes a lower base 123a that is curved and shaped to engage a corresponding curved mounting region 122 in the foot 120. From the base 123a, two pairs of tines 123b extends upwards. One pair of tines 123b interfaces with a ridge in a contoured mounting region 112 of the cartridge body thereby securing the bracket to the cartridge body, while the other pair of tines 123b engage an opposite facing side of the flange of the fluidic interface of the biochip carrier device 10. In some embodiments, personnel fits the fluidic interface of the biochip carrier device 10 within the mounting region 112 of a completed and tested cartridge body, then slides the fork bracket 123 from the bottom, thereby engaging opposite facing surfaces of the mounting region 112 and the fluidic interface flange, thereby securing the biochip carrier device to the cartridge body. The cartridge foot 120 is than attached to the cartridge body, abutting against the base of the fork, thereby locking the biochip carrier device to the cartridge. It is appreciated that various other similar features can be used to facilitate attachment of the biochip carrier device post-cartridge production.

Table 1 below shows exemplary materials of which the various components described herein can be formed. It is appreciated that these are illustrative of certain embodiments described herein and that other embodiments may include same or similar components of the materials or various combinations of elements formed of these or other suitable materials.

TABLE 1
Exemplary Materials of Various Components

| | Component | | Assembly |
|---|---|---|---|
| | Manufacturing | | Manufacturing |
| Material | Method | Design | Method |
| COP 1420R | Injection molding | Foot Fork | Laser welding |
| | (1 shot, 2 shots) | | |
| COP Film ZF14 | Compression | DIG Flat Gasket | Heat swaging, staking |
| | Molding | | |
| Glass | | DIG Profile Gasket | Annealing |
| PMMA | | Overmold TPE | Adhesive bonding |
| LSR (different | | DIG Frames | Snapping |
| grades) | | | |
| PolyCarbonate | | One piece frame | Solvent bonding |
| Adhesive tapes | | PCB stake | |
| Adhesives | | Swage Bar design | |
| Epoxy, Epoxy | | Heat stake post design | |
| preform | | | |
| Stainless Steel | | Ultrasonic welding | |
| retainer | | design | |
| Overmolded Gasket | | Liquid Adhesive | |
| (“Kraiburg”) | | Design | |

In the foregoing specification, the disclosure is described with reference to specific embodiments thereof, but those skilled in the art will recognize that the disclosure is not limited thereto. Various features, embodiments and aspects of the above-described disclosure can be used individually or jointly. Further, the disclosure can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

1. A diagnostic chip carrier device comprising:
a planar frame having a fluidic interface at one end that is fluidically coupled to one or more fluidic passages extending to a contoured region shaped near the opposite end, the contoured region being shaped to receive a diagnostic chip;
an overmolded gasket sealingly coupled with the planar frame within the contoured region, wherein the gasket is shaped to partly define a flowcell chamber adjacent an active surface of the chip when disposed within the contoured region; and
a window coupled with the frame adjacent the flowcell chamber to allow optical detection through the window of the active surface of the diagnostic chip when disposed within the contoured region.

2. The diagnostic chip carrier device of claim 1, wherein the planar frame further includes an access opening positioned to allow access to a plurality of contacts disposed on the diagnostic chip when disposed within the contoured region.

3. (canceled)

4. The diagnostic chip carrier device of claim 1, further comprising:
a printed circuit board (PCB) or substrate attached to one major surface of the planar frame so as to secure the diagnostic chip within the contoured region.

5. (canceled)

6. (canceled)

7. (canceled)

8. The diagnostic chip carrier device of claim 1, further comprising:
a glass window inlaid or molded within the frame adjacent the flowcell to allow optical detection of an active surface of the diagnostic chip when disposed within the contoured region.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A diagnostic chip carrier device comprising:
a planar frame having a fluidic interface at one end that is fluidically coupled to one or more fluidic passages extending to a recessed region shaped near the opposite end, the recessed region being disposed on a major planar face and shaped to receive a diagnostic chip;
a flowcell chamber adjacent to the recessed region such that an active surface of the chip is exposed to the flowcell chamber when disposed within the recessed region; and
an opening adjacent the flowcell chamber on an opposite major face of the planar frame to allow optical detection through the opening of the active surface of the diagnostic chip when disposed within the recessed region.

23. The diagnostic chip carrier device of claim 22, further comprising:
a gasket formed of a compressible material such that, when compressed by the chip secured in the frame, the gasket compresses to form a fluid-tight seal.

24. The diagnostic chip carrier device of claim 23, wherein the gasket is formed of silicone.

25. The diagnostic chip carrier device of claim 23, wherein the gasket is formed of silicone having a shore hardness of 50 A-60 A.

26. The diagnostic chip carrier device of claim 23, wherein the gasket has a thickness of 0.4-0.5 mm.

27. The diagnostic chip carrier device of claim 23, wherein the gasket has a circular cross-section.

28. The diagnostic chip carrier device of claim 23, wherein the gasket is substantially square in shape and corresponds in size to the recessed region on which the chip is secured.

29. The diagnostic chip carrier device of claim 23, wherein the frame further include a ridge circumscribing the flowcell chamber to increase compression of the gasket to facilitate sealing.

30. The diagnostic chip carrier device of claim 23, wherein the frame further a double ridge circumscribing the flowcell chamber to increase compression of the gasket to facilitate sealing.

31. The diagnostic chip carrier device of claim 22, wherein the frame further comprises a pair of swage beams on opposite sides of the recessed region to facilitate swaging of the chip on the recessed region with the gasket disposed between the chip and the frame.

32. (canceled)

33. (canceled)

34. (canceled)

35. The diagnostic chip carrier device of claim 22, wherein the frame further comprises a plurality of posts arranged around the recessed region to facilitate heat staking of the chip within the recessed region.

36. (canceled)

37. (canceled)

38. The diagnostic chip carrier device of claim 22, further comprising:
an optical lid secured to the opposite major face of the planar frame and enclosing one side of the flowcell chamber to allow optical detection of the active face of the chip when secured within the recessed portion.

39. (canceled)

40. (canceled)

41. (canceled)

42. (canceled)

43. (canceled)

44. (canceled)

45. (canceled)

46. A gasket positioning device comprising:
an elongate tool extending to a distal grasper configured to pick up and release a gasket at a pre-determined position within the grasper, wherein the grasper includes one or more alignment features; and
a fixture base configured with a nesting region to support a chip carrier frame, wherein the fixture base comprise one or more corresponding alignment features configured to engage with the one or more alignment features of the grasper to ensure positioning of the gasket at a precise position within a recessed portion of the chip carrier frame.

47. The gasket positioning device of claim 46, wherein the one or more alignment features comprise three or more protruding arms that engage at least three edges of the frame and/or fixture base.

48. The gasket positioning device of claim 46, wherein grasper comprises one or more pneumatic ports coupled to a pressurization means and configured to facilitate picking up the gasket by suction and release of the gasket by compressed air.

49. The gasket positioning device of claim 46, wherein the tool is configured to be manually beld and positioned and the grasper is actuated by a manual control.

50. (canceled)

51. (canceled)

52. (canceled)

53. (canceled)

54. (canceled)

55. (canceled)

56. (canceled)

57. (canceled)

58. (canceled)

59. (canceled)

60. (canceled)
